(19) United States
(12) Patent Application Publication
(10) Pub. No.: US 2025/0318528 A1
(43) Pub. Date: Oct. 16, 2025

(54) HERBICIDE COMPOSITION AND WEED CONTROLLING METHOD

(71) Applicant: SUMITOMO CHEMICAL COMPANY, LIMITED, Tokyo (JP)

(72) Inventors: Yoshinobu JIN, Takarazuka-shi (JP); Mai TORIUMI, Osaka-shi (JP)

(73) Assignee: SUMITOMO CHEMICAL COMPANY, LIMITED, Tokyo (JP)

(21) Appl. No.: 18/866,101

(22) PCT Filed: May 23, 2023
(86) PCT No.: PCT/JP2023/019092

§ 371 Date: Nov. 15, 2024

(30) Foreign Application Priority Data
May 25, 2022 (JP) 2022-085416
Jun. 14, 2022 (JP) 2022-095564

(51) Int. Cl. A01N 43/54; A01P 13/00

(52) U.S. Cl. CPC A01N 43/54; A01P 13/00

(57) ABSTRACT

Provided is a herbicidal composition comprising one or more uracil compounds represented by formula (I) and one or more compounds selected from the group consisting of the herbicide compound group B consisting of the following B-1 to B-12.

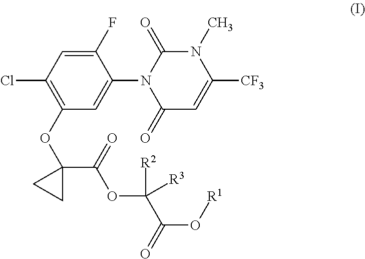

### TECHNICAL FIELD

The present invention relates to a herbicidal composition and a method for controlling weeds.

### BACKGROUND ART

At present, many herbicides are commercially available and used. Many PPO-inhibiting herbicides have been used for the purpose of controlling weeds, and, for example, uracil compounds having herbicidal activity have been known as an active ingredient for the PPO-inhibiting herbicides.

### PRIOR ART DOCUMENT

### Patent Document

[Patent Document 1] U.S. Pat. No. 6,403,534

### DISCLOSURE OF THE INVENTION

### Problems to be Solved by the Invention

An object of the present invention is to provide a herbicidal composition having excellent control effect on weeds and a method for controlling weeds.

### Means for Solving the Problems

The present inventors have found that excellent control effect on weeds is exerted by using one or more uracil compounds represented by the following formula (I) in combination with a specific compound.

The present invention includes the following aspects.
[1] A herbicidal composition comprising one or more uracil compounds represented by the following formula (I):

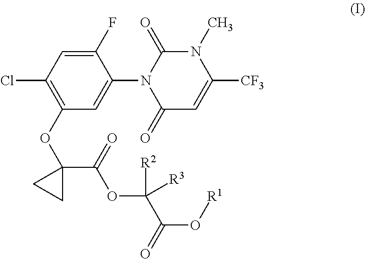

wherein,
   R¹ represents a hydrogen atom, a methyl group, or an ethyl group,
   R² represents an alkyl group having 1 to 3 carbon atoms,
   R³ represents a hydrogen atom or an alkyl group having 1 to 3 carbon atoms, and
   R² and R³ may be bonded to each other to form a C2-3 alkylene chain,
   and one or more compounds selected from the herbicide compound group B, and
   the herbicide compound group B is the group consisting of the following B-1 to B-12:
   B-1, acetolactate synthase inhibitors;
   B-2, acetyl COA carboxylase inhibitors;
   B-3, protoporphyrinogen IX oxidase inhibitors;
   B-4, 4-hydrophenylpyruvic acid dioxygenase inhibitors;
   B-5, phytoene desaturase inhibitors;
   B-6, photosystem II inhibitors;
   B-7, very-long-chain fatty acid synthesis inhibitors;
   B-8, microtubule formation inhibitors;
   B-9, auxin-type herbicides;
   B-10, enolpyruvylshikimate-3-phosphate synthase inhibitors;
   B-11, glutamine synthase inhibitors; and
   B-12, other herbicides;
(including agriculturally acceptable salts or derivatives thereof).
[2] The herbicidal composition according to [1], wherein the B-1 is the group consisting of:
pyrithiobac, pyrithiobac-sodium salt, pyriminobac, pyriminobac-methyl, bispyribac, bispyribac-sodium salt, pyribenzoxim, pyrimisulfan, pyriftalid, triafamone, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron methyl-sodium, foramsulfuron, halosulfuron, halosulfuron-methyl, imazosulfuron, metsulfuron, metsulfuron-methyl, metazosulfuron, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron, trifloxysulfuron-sodium salt, chlorsulfuron, cinosulfuron, ethametsulfuron, ethametsulfuron-methyl, iodosulfuron, iodosulfuron-methyl-sodium, iofensulfuron, iofensulfuron-sodium, mesosulfuron, mesosulfuron-methyl, prosulfuron, thifensulfuron, thifensulfuron-methyl, triasulfuron, tribenuron, tribenuron-methyl, triflusulfuron, triflusulfuron-methyl, tritosulfuron, bencarbazone, flucarbazone, flucarbazone-sodium salt, propoxycarbazone, propoxycarbazone-sodium salt, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium salt, imazapic, imazapic-ammonium salt, imazapyr, imazapyr-isopropylammonium salt, imazaquin, imazaquin-ammonium salt, imazethapyr, and imazethapyr-ammonium salt (including agriculturally acceptable salts or derivatives thereof),
   the B-2 is the group consisting of:
clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-ethotyl, haloxyfop-methyl, haloxyfop-P, haloxyfop-P-ethotyl, haloxyfop-P-methyl, metamifop, propaquizafop, quizalofop, quizalofop-tefuryl, quizalofop-ethyl, quizalofop-P, quizalofop-P-tefuryl, quizalofop-P-ethyl, alloxydim, butroxydim, clethodim, cycloxydim, profoxydim, sethoxydim, tepraloxydim, tralkoxydim, and pinoxaden (including agriculturally acceptable salts or derivatives thereof),
   the B-3 is the group consisting of:
azafenidin, benzfendizone, oxadiazone, oxadiargyl, carfentrazone, carfentrazone-ethyl, saflufenacil, cinidon, cinidon-ethyl, sulfentrazone, pyraclonil, cyclopyranil, pyraflufen, pyraflufen-ethyl, butafenacil, fluazolate, fluthiacet, fluthiacet-methyl, flufenpyr, flufenpyr-ethyl, flumiclorac, flumiclorac-pentyl, flumioxazin, pentoxazone, oxyfluorfen, acifluorfen, acifluorfen-sodium salt, chlomethoxynil, chloronitrofen, nitrofen, bifenox, chlomethoxyfen, ethoxyfentyl, fluoroglycofen, fluoroglycofen-ethyl, fomesafen, fomesafen-sodium, halosafen, lactofen, tiafenacil, trifludimoxazin, thidiazimin, profluazole, and epyrifenacil
(including agriculturally acceptable salts or derivatives thereof),
   the B-4 is the group consisting of:
benzobicyclon, bicyclopyrone, mesotrione, sulcotrione, tefuryltrione, tembotrione, isoxachlorotole, isoxaflutole, benzofenap, pyrasulfotole, pyrazolynate, pyrazoxyfen, fenquinotrione, topramezone, tolpyralate, lancotrione, lancotrione-sodium salt, 2-methyl-N-(5-methyl-1,3,4-oxadiazol-2-yl)-3-(methanesulfonyl)-4-(trifluoromethyl)benzamide (CAS registry No.: 1400904-50-8), 2-chloro-N-(1-methyl-1H-tetrazol-5-yl)-3-(methylthio)-4-(trifluoromethyl)benzamide (CAS registry No.: 1361139-71-0), 4-(4-fluorophenyl)-6-[(2-hydroxy-6-oxo-1-cyclohexen-1-yl)carbonyl]-2-methyl-1,2,4-triazine-3,5(2H,4H)-dione (CAS registry No.: 1353870-34-4), and 3-[(isopropylsulfonyl)methyl]-N-(5-methyl-1,3,4-oxadiazol-2-yl)-5-(trifluoromethyl)-1,2,4-triazolo[4,3-a]pyridine-8-carboxamide (CAS registry No.: 1994348-72-9) (including agriculturally acceptable salts or derivatives thereof),
   the B-5 is the group consisting of:
diflufenican, picolinafen, beflubutamid, norflurazon, fluridone, flurochloridone, and flurtamone (including agriculturally acceptable salts or derivatives thereof),
   the B-6 is the group consisting of:
ioxynil, ioxynil octanoate, bentazone, pyridafol, pyridate, bromophenoxym, bromoxynil, bromoxynil octanoate, chlorbromuron, chlorotoluron, chloroxuron, dimefuron, diuron, ethidimuron, fenuron, linuron, fluometuron, isoproturon, isouron, tebuthiuron, azuron, methabenzthiazuron, neburon, pentanochlor, propanil, metobromuron, metoxuron, monolinuron, siduron, simazine, atrazine, desmetryn, propazine, cyanazine, ametryn, simetryn, dimethametryn, prometon, prometryn, terbumeton, terbuthylazine, terbutryn, trietazine, hexazinone, metamitron, metribuzin, amicarbazone, bromacil, lenacil, terbacil, chloridazon, desmedipham, and phenmedipham (including agriculturally acceptable salts or derivatives thereof),
   the B-7 is the group consisting of:
propachlor, metazachlor, alachlor, acetochlor, aridchlor, dimethachlor, metolachlor, S-metolachlor, butachlor, pretilachlor, propisochlor, thenylchlor, indanofan, cafenstrole, fentrazamide, diphenamid, dimethenamid, dimethenamid-P, dimepiperate, mefenacet, pyroxasulfone, fenoxasulfone, naproanilide, napropamide, napropamide M, pethoxamid, anilofos, piperofos, flufenacet, dimesulfazet, and ipfencarbazone
(including agriculturally acceptable salts or derivatives thereof),
   the B-8 is the group consisting of:
trifluralin, pendimethalin, ethalfluralin, benfluralin, oryzalin, prodiamine, butamifos, dithiopyr, thiazopyr, amiprophos-methyl, carbetamide, chlorthal-dimethyl, butralin, dinitramine, propham, propyzamide, and tebutam
(including agriculturally acceptable salts or derivatives thereof),
   the B-9 is the group consisting of:
2,3,6-TBA and a salt or ester thereof (dimethylammonium, lithium salt, potassium salt, sodium salt), 2,4-D and a salt or ester thereof (choline salt, tetrabutylammonium salt, biproamine, doboxyl, 2-ethylhexyl, 3-butoxypropyl, ammonium, butotyl, butyl, diethylammonium, dimethylammonium, diolamine salt, dodecylammonium, ethyl, heptylammonium, isobutyl, isooctyl, isopropyl, isopropylammonium, lithium salt, meptyl, methyl, octyl, pentyl, propyl, sodium salt, tefuryl, tetradecylammonium, triethylammonium, tris(2-hydroxypropyl)ammonium, and trolamine salt), 2,4-DB and a salt or ester thereof (choline salt, biproamine, butyl, dimethylammonium, isooctyl, potassium salt and sodium salt), MCPA and a salt or ester thereof (choline salt, biproamine, etexyl, butotyl, butyl, dimethylammonium, diolamine salt, ethyl, isobutyl, isooctyl, isopropyl, methyl, olamine salt, sodium salt and trolamine salt), MCPB and a salt or ester thereof (choline salt, biproamine, ethyl, methyl and sodium salt), mecoprop and a salt or ester thereof (choline salt, biproamine, 2-ethylhexyl, dimethylammonium, diolamine salt, ethadyl, isooctyl, methyl, potassium salt, sodium salt and trolamine salt), mecoprop-P and a salt or ester thereof (choline salt, 2-ethylhexyl, dimethylammonium, isobutyl, and potassium salt), dichlorprop and a salt or ester thereof (choline salt, biproamine, etexyl, butotyl, dimethylammonium, ethylammonium, isooctyl, methyl, potassium salt and sodium salt), dichlorprop-P and a salt or ester thereof (choline salt, biproamine, etexyl and dimethylammonium), dicamba and a salt or ester thereof (choline salt, biproamine, trolamine salt, diglycolamine salt, dimethylammonium, diolamine salt, isopropylammonium, methyl, olamine salt, potassium salt, sodium salt and tetrabutylammonium salt), triclopyr and a salt or ester thereof (butotyl, ethyl and triethylammonium), fluroxypyr and a salt or ester thereof (meptyl and butometyl), picloram and a salt thereof (potassium salt, tris(2-hydroxypropyl)ammonium salt and choline salt), quinclorac, quinmerac, aminopyralid and a salt thereof (choline salt, potassium salt and tripromine), clopyralid and a salt thereof (choline salt, methyl, olamine salt, potassium salt, tris(2-hydroxypropyl)ammonium, and triethylammonium salt), clomeprop, aminocyclopyrachlor and a salt thereof (methyl, potassium salt), halauxifen, halauxifen-methyl, florpyrauxifen, florpyrauxifen-benzyl, benazolin-ethyl, chloramben, 4-amino-3-chloro-5-fluoro-6-(7-fluoro-1H-indol-6-yl)pyridine-2-carboxylic acid, and 4-amino-3-chloro-5-fluoro-6-(7-fluoro-1H-indol-6-yl)pyridine-2-carboxylic cyanomethyl ester (including agriculturally acceptable salts or derivatives thereof),
   the B-10 is the group consisting of:
glyphosate, glyphosate choline salt, glyphosate-isopropylammonium, glyphosate biproamine, glyphosate-trimesium, glyphosate-ammonium salt, glyphosate-diammonium salt, glyphosate-dimethylammonium salt, glyphosate-monoethanolamine salt, glyphosate-sodium salt, glyphosate-potassium salt, and glyphosate-guanidine salt
(including agriculturally acceptable salts or derivatives thereof),
   the B-11 is the group consisting of:
glufosinate, glufosinate-ammonium salt, glufosinate-P, glufosinate-P-sodium salt, glufosinate-P-ammonium salt, and bialaphos
(including agriculturally acceptable salts or derivative thereof), and
   the B-12 is the group consisting of:
aclonifen, isoxaben, dichlobenil, thaxtomin A, methiozolin, diallate, butylate, triallate, chlorpropham, asulam, phenisopham, benthiocarb, molinate, esprocarb, pyributicarb, prosulfocarb, orbencarb, EPTC, dimepiperate, swep, difenoxuron, methyl daimuron, bromobutide, daimuron, cumyluron, diflufenzopyr, diflufenzopyr-sodium salt, naptalam, etobenzanid, tridiphane, amitrole, clomazone, bixlozone, maleic hydrazide, oxaziclomefone, cinmethylin, benfuresate, ACN, dalapon, chlorthiamid, flupoxam, bensulide, paraquat, paraquat-dichloride, diquat, diquat-dibromide, MSMA, indaziflam, triaziflam, tetflupyrolimet, dinoseb, dinoterb, DNOC, cycloate, ethofumesate, flupropanate, pebulate, TCA, TCA-ammonium, TCA-calcium, TCA-ethadyl, TCA-magnesium, TCA-sodium, tiocarbazil, vernolate, cyclopyrimorate, dazomet, difenzoquat, difenzoquat methyl sulphate, DSMA, flamprop M, flurenol, fosamine, metam, oleic acid, pelargonic acid, (2R,4R)-4-({[(5S)-3-(3,5-difluorofenyl)-5-vinyl-4,5-dihydroisoxazol-5-yl]carbonyl}amino)tetrahydrofuran-2-carboxylic methyl ester and (2S,4S)-4-({[(5R)-3-(3,5-difluorofenyl)-5-vinyl-4,5-dihydroisoxazol-5-yl]carbonyl}amino)tetrahydrofuran-2-carboxylic methyl ester, icafolin-methyl (CAS registry No.: 2749998-21-6), 1-{2-chloro-6-[(5-chloropyrimidin-2-yl)oxy]phenyl}-4,4,4-trifluorobutan-1-one (CAS registry No.: 2052297-97-7), and rimisoxafen (CAS registry No.: 1801862-02-1)
(including agriculturally acceptable salts or derivatives thereof).
[3] The herbicidal composition according to [1] or [2], wherein the B-1 is the group consisting of:
pyrithiobac, pyrithiobac-sodium salt, chlorimuron-ethyl, foramsulfuron, halosulfuron-methyl, nicosulfuron, primisulfuron-methyl, rimsulfuron, trifloxysulfuron-sodium salt, chlorsulfuron, iodosulfuron-methyl-sodium, iofensulfuron-sodium, mesosulfuron-methyl, prosulfuron, thifensulfuron-methyl, tribenuron-methyl, thiencarbazone-methyl, cloransulam-methyl, flumetsulam, imazamethabenz-methyl, imazamox-ammonium salt, imazapic-ammonium salt, imazapyr-isopropylammonium, imazaquin-ammonium salt, and imazethapyr-ammonium salt
(including agriculturally acceptable salts or derivatives thereof).
[4] The herbicidal composition according to any one of [1] to [3], wherein the B-2 is the group consisting of:
fenoxaprop-ethyl, fenoxaprop-P-ethyl, fluazifop-butyl, fluazifop-P-butyl, quizalofop-ethyl, quizalofop-P-ethyl, clethodim, and sethoxydim
(including agriculturally acceptable salts or derivatives thereof).
[5] The herbicidal composition according to any one of [1] to [4], wherein the B-3 is the group consisting of:
carfentrazone-ethyl, saflufenacil, sulfentrazone, pyraflufen-ethyl, fluthiacet-methyl, flufenpyr-ethyl, flumiclorac-pentyl, flumioxazin, oxyfluorfen, acifluorfen-sodium salt, fomesafen-sodium, lactofen, tiafenacil, trifludimoxazin, and epyrifenacil
(including agriculturally acceptable salts or derivatives thereof).
[6] The herbicidal composition according to any one of [1] to [5], wherein the B-4 is the group consisting of:
bicyclopyrone, mesotrione, tembotrione, isoxaflutole, fenquinotrione, topramezone, tolpyralate, lancotrione-sodium salt, 2-methyl-N-(5-methyl-1,3,4-oxadiazol-2-yl)-3-(methanesulfonyl)-4-(trifluoromethyl)benzamide (CAS registry No. 1400904-50-8), 2-chloro-N-(1-methyl-1H-tetrazol-5-yl)-3-(methylthio)-4-(trifluoromethyl)benzamide (CAS registry No. 1361139-71-0), and 4-(4-fluorophenyl)-6-[(2-hydroxy-6-oxo-1-cyclohexen-1-yl)carbonyl]-2-methyl-1,2,4-triazine-3,5(2H,4H)-dione (CAS registry No. 1353870-34-4)
(including agriculturally acceptable salts or derivatives thereof).
[7] The herbicidal composition according to any one of [1] to [6], wherein the B-5 is the group consisting of:
norflurazon and fluridone
(including agriculturally acceptable derivatives thereof).
[8] The herbicidal composition according to any one of [1] to [7], wherein the B-6 is the group consisting of:
bentazone, bromoxynil octanoate, diuron, linuron, fluometuron, simazine, atrazine, ametryn, prometryn, and metribuzin
(including agriculturally acceptable salts or derivatives thereof).
[9] The herbicidal composition according to any one of [1] to [8], wherein the B-7 is the group consisting of:
alachlor, acetochlor, metolachlor, S-metolachlor, dimethenamid, dimethenamid-P, pyroxasulfone, and flufenacet (including agriculturally acceptable derivatives thereof).
[10] The herbicidal composition according to any one of [1] to [9], wherein the B-8 is the group consisting of:
trifluralin, pendimethalin, and ethalfluralin (including agriculturally acceptable derivative thereof).
[11] The herbicidal composition according to any one of [1] to [10], wherein
the B-9 is the group consisting of:
2,4-D, 2,4-D choline salt, 2,4-DB, dicamba, dicamba-biproamine, dicamba-diglycolamine salt, fluroxypyr, fluroxypyr-meptyl, clopyralid-olamine salt, clopyralid-potassium salt, clopyralid-triethylammonium salt, halauxifen, halauxifen-methyl, florpyrauxifen, and florpyrauxifen-benzyl
(including agriculturally acceptable salts or derivatives thereof).
[12] The herbicidal composition according to any one of [1] to [11], wherein the B-10 is the group consisting of:
glyphosate, glyphosate-isopropylammonium, glyphosate-ammonium salt, glyphosate-dimethylamine salt, glyphosate-monoethanolamine salt, glyphosate-potassium salt, and glyphosate-guanidine salt
(including agriculturally acceptable salts or derivatives thereof).
[13] The herbicidal composition according to any one of [1] to [12], wherein the B-11 is the group consisting of:
glufosinate, glufosinate-ammonium salt, glufosinate-P, and glufosinate-P-sodium salt
(including agriculturally acceptable salts or derivatives thereof).
[14] The herbicidal composition according to any one of [1] to [13], wherein the B-12 is the group consisting of: EPTC, diflufenzopyr, diflufenzopyr-sodium salt, clomazone, bixlozone, cinmethylin, MSMA, paraquat, paraquat-dichloride, diquat, diquat-dibromide, tetflupyrolimet, and rimisoxafen (including agriculturally acceptable salts or derivatives thereof).
[15] The herbicidal composition according to any one of [1] to [14], further comprising a carrier.
[16] A method for controlling weeds, comprising a step of simultaneously or sequentially applying one or more uracil compounds represented by the following formula (I):

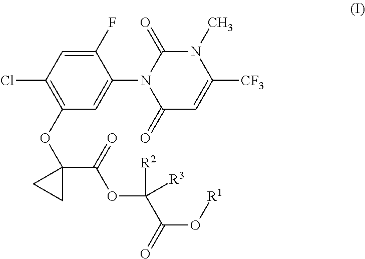

wherein,
   R¹ represents a hydrogen atom, a methyl group, or an ethyl group,
   R² represents an alkyl group having 1 to 3 carbon atoms,
   R³ represents a hydrogen atom or an alkyl group having 1 to 3 carbon atoms, and
   R² and R³ may be bonded to each other to form a C2-3 alkylene chain,
   and one or more compounds selected from the herbicide compound group B to the place where weeds are growing or will grow, wherein
   the herbicide compound group B is the group consisting of the following B-1 to B-12:
   B-1, acetolactate synthase inhibitors;
   B-2, acetyl COA carboxylase inhibitors;
   B-3, protoporphyrinogen IX oxidase inhibitors;
   B-4, 4-hydrophenylpyruvic acid dioxygenase inhibitors;
   B-5, phytoene desaturase inhibitors;
   B-6, photosystem II inhibitors;
   B-7, very-long-chain fatty acid synthesis inhibitors;
   B-8, microtubule formation inhibitors;
   B-9, auxin-type herbicides;
   B-10, enolpyruvylshikimate-3-phosphate synthase inhibitors;
   B-11, glutamine synthase inhibitors; and
   B-12, other herbicides;
(including agriculturally acceptable salts or derivatives thereof).
[17] The method for controlling weeds according to [16], wherein a weight ratio of an application rate of the uracil compounds to that of one or more compounds selected from the group consisting of the herbicide compound group B is 1:10\hat{ }15 to 10\hat{ }15:1.
[18] The method for controlling weeds according to [16] or [17], wherein the place where weeds are growing or will grow is a crop field.
[19] Use of the herbicidal composition according to any one of [1] to [15], for controlling weeds.

### Effects of the Invention

According to the present invention, it becomes possible to highly effectively control weeds.

### MODE FOR CARRYING OUT THE INVENTION

The herbicidal composition of the present invention (hereinafter referred to as present composition) comprises one or more uracil compounds represented by the above formula (I) (hereinafter referred to as compound (I)) and one or more compounds selected from the herbicide compound group B (hereinafter referred to as compound (B)). The present composition can further comprise one or more compounds selected from the safener group C (hereinafter referred to as compound (C)).

The method for controlling weeds of the present invention (hereinafter referred to as present method) comprises a step of simultaneously applying or a step of sequentially applying one or more compounds (I), one or more compounds (B), and as necessary, the compound (C) to the place where weeds are growing or will grow. When simultaneously applying, the present composition is applied. When sequentially applying, the order of applying the compound (I) and the compound (B) is not particularly limited. When using the compound (C) in sequential application, the order of applying the compound (I), the compound (B), and the compound (C) is not particularly limited.

In the present method, the compound (I), the compound (B), and as necessary, the compound (C) are applied to the place where weeds are growing or will grow in a crop field, a vegetable field, an orchard or a non-crop area. In the crop field, the compound (I), the compound (B), and as necessary, the compound (C) may be applied before, simultaneously with and/or after seeding crop seeds.

The present composition is used for controlling weeds. The method for applying the present composition includes, for example, a method for spraying the present composition on the soil of a cultivation field and a method for spraying the present composition to weeds grown. Spraying the present composition is usually performed by spraying a spray liquid obtained by mixing the present composition with water, using a spraying machine. The spray liquid amount is not particularly limited and is usually 50 to 1,000 L/ha, preferably 100 to 500 L/ha, and more preferably 140 to 300 L/ha.

The application rate of the compound (I) and the compound (B) (the total of the compound (B) and the compound (C) when using the compound (C)) is, as the total amount of the compound (I) and the compound (B) (the total of the compound (B) and the compound (C) when using the compound (C)), usually 1 to 10,000 g per 10,000 m², preferably 2 to 5,000 g per 10,000 m², and more preferably 5 to 2,000 g per 10,000 m².

In the present method, the compound (I), the compound (B), and as necessary, the compound (C) and an adjuvant may be used in combination.

The type of the adjuvant is not particularly limited, and it is desirable to use in combination with oil-based adjuvants such as Agri-Dex and MSO (Methylated Seed Oils obtained by esterifying mineral oils such as paraffin-based hydrocarbons, naphthene-based hydrocarbons and aromatic hydrocarbons or vegetable oils (soybean oil and rapeseed oil)) at a ratio of 0.25%, 0.5%, 1%, 2%, 3%, 4%, 5% or 6% (volume/volume) in the spray liquid, or nonionic adjuvants such as Induce (polyoxyalkylene alkyl ether, polyoxyalkylene fatty acid ester, alkyl aryl alkoxylate, or alkyl aryl polyoxyalkylene glycol) at a ratio of 0.05%, 0.1%, 0.25% or 0.5% (volume/volume) in the spray liquid. Other examples include anionic adjuvants such as Gramin S (substituted sulfonate), cationic adjuvants such as Genamin T 200BM (polyoxyethylene amine), and organosilicon-based adjuvants such as Silwett L77. A drift-reducing agent such as Intact (polyoxyethylene glycol) may also be used in combination.

The pH and hardness of the spray liquid prepared when applying the compound (I), the compound (B), and as necessary, the compound (C) are not particularly limited, and the pH is usually within a range of 5 to 9 and the hardness is usually within a range of 0 to 500 ppm as American degrees.

The period of time for applying the compound (I), the compound (B), and as necessary, the compound (C) is not particularly limited, and the period of time is usually within a range of 5 a.m. to 9 p.m., and the photon flux density the place to be applied is usually 10 to 2,500 μmol/m2/second. The temperature at the place to be applied is usually 0 to 35 degrees Celsius, and the wind velocity is usually 3 MPH or less.

The spraying pressure to be employed for the application of the compound (I), the compound (B), and as necessary, the compound (C) is not particularly limited, and is usually 30 to 120 PSI, and preferably 40 to 80 PSI.

The compound (I) is an uracil compound represented by the following formula (I).

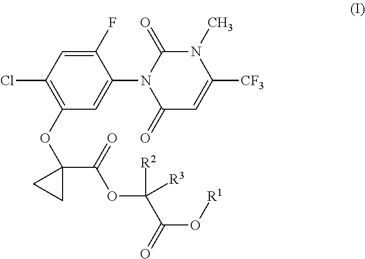

The present composition comprises one or more types of compounds (I).

In formula (I), R¹ represents a hydrogen atom, a methyl group, or an ethyl group, R² represents an alkyl group having 1 to 3 carbon atoms, R³ represents a hydrogen atom or an alkyl group having 1 to 3 carbon atoms, R² and R³ may be bonded to each other to form a C2-3 alkylene chain, and the C2-3 alkylene chain means —(CH₂)₂— or —(CH₂)₃—.

When R² and R³ are different groups from each other, carbon to which R² and R³ are bonded is an asymmetric center. In this case, the compound (I) may be either one enantiomer, or a mixture of two types of enantiomers. The mixture may also be a racemic mixture.

Examples of the compound (I) include compounds shown in Table 1. In Table 1, Me represents a methyl group, Et represents an ethyl group, and Pr represents a propyl group. —(CH₂)₂— represents that R² and R³ may be bonded to each other to form —(CH₂)₂—. —(CH₂)₃-represents that R² and R³ may be bonded to each other to form —(CH₂)₃—.

TABLE 1

| Compound | R¹ | R² | R³ |
|---|---|---|---|
| (I-1) | H | Me | H |
| (I-2) | H | Me | Me |
| (I-3) | H | Me | Et |
| (I-4) | H | Me | Pr |
| (I-5) | H | Et | H |
| (I-6) | H | Et | Me |
| (I-7) | H | Et | Et |
| (I-8) | H | Et | Pr |
| (I-9) | H | Pr | H |
| (I-10) | H | Pr | Me |
| (I-11) | H | Pr | Et |
| (I-12) | H | Pr | Pr |

| | | |
|---|---|---|
| (I-13) | H | —(CH₂)₂— |
| (I-14) | H | —(CH₂)₃— |

| | | | |
|---|---|---|---|
| (I-15) | Me | Me | H |
| (I-16) | Me | Me | Me |
| (I-17) | Me | Me | Et |
| (I-18) | Me | Me | Pr |
| (I-19) | Me | Et | H |
| (I-20) | Me | Et | Me |
| (I-21) | Me | Et | Et |
| (I-22) | Me | Et | Pr |
| (I-23) | Me | Pr | H |
| (I-24) | Me | Pr | Me |
| (I-25) | Me | Pr | Et |
| (I-26) | Me | Pr | Pr |

| | | |
|---|---|---|
| (I-27) | Me | —(CH₂)₂— |
| (I-28) | Me | —(CH₂)₃— |

| | | | |
|---|---|---|---|
| (I-29) | Et | Me | H |
| (I-30) | Et | Me | Me |
| (I-31) | Et | Me | Et |
| (I-32) | Et | Me | Pr |
| (I-33) | Et | Et | H |
| (I-34) | Et | Et | Me |
| (I-35) | Et | Et | Et |
| (I-36) | Et | Et | Pr |
| (I-37) | Et | Pr | H |
| (I-38) | Et | Pr | Me |
| (1-39) | Et | Pr | Et |
| (I-40) | Et | Pr | Pr |

| | | |
|---|---|---|
| (I-41) | Et | —(CH₂)₂— |
| (I-42) | Et | —(CH₂)₃— |

R¹ is preferably a methyl group or an ethyl group. R² is preferably a methyl group or an ethyl group. R³ is preferably a hydrogen atom or a methyl group. It is also preferable that R² and R³ may be bonded to each other to form a C2-3 alkylene chain.

The compound (I) preferably includes one or more compounds selected from the group consisting of a compound (I-15) to a compound (I-42), more preferably includes one or more compounds selected from the group consisting of a compound (I-15) to a compound (I-17), a compound (I-19) to a compound (I-21), a compound (I-27) to a compound (I-31), a compound (I-33) to a compound (I-35), a compound (I-41) and a compound (I-42), and still more preferably includes one or more compounds selected from the group consisting of a compound (I-15), a compound (I-29), a compound (I-30), a compound (I-33) and a compound (I-41).

The compound (I) can be produced according to the method mentioned in U.S. Pat. No. 6,403,534.

The compound (B) is a compound selected from the herbicide compound group B. The present composition comprises one or more types of compound (B). According to the present composition comprising one or more compounds (I) and one or more compounds (B), it becomes possible to exert excellent control effect on weeds.

The herbicide compound group B is the group consisting of the following B-1 to B-12. The following inhibitors or herbicides B-1 to B-12 include agriculturally acceptable salts or derivatives of the inhibitors or the herbicides:
B-1, acetolactate synthase inhibitors;
B-2, acetyl CoA carboxylase inhibitors;
B-3, protoporphyrinogen IX oxidase inhibitors;
B-4, 4-hydrophenylpyruvic acid dioxygenase inhibitors;
B-5, phytoene desaturase inhibitors;
B-6, photosystem II inhibitors;
B-7, very-long-chain fatty acid synthesis inhibitors;
B-8, microtubule formation inhibitors;
B-9, auxin-type herbicides;
B-10, enolpyruvylshikimate-3-phosphate synthase inhibitors;
B-11, glutamine synthase inhibitors; and
B-12, other herbicides.

B-1 is preferably the group consisting of pyrithiobac, pyrithiobac-sodium salt, pyriminobac, pyriminobac-methyl, bispyribac, bispyribac-sodium salt, pyribenzoxim, pyrimisulfan, pyriftalid, triafamone, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron methyl-sodium, foramsulfuron, halosulfuron, halosulfuron-methyl, imazosulfuron, metsulfuron, metsulfuron-methyl, metazosulfuron, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron, trifloxysulfuron-sodium salt, chlorsulfuron, cinosulfuron, ethametsulfuron, ethametsulfuron-methyl, iodosulfuron, iodosulfuron-methyl-sodium, iofensulfuron, iofensulfuron-sodium, mesosulfuron, mesosulfuron-methyl, prosulfuron, thifensulfuron, thifensulfuron-methyl, triasulfuron, tribenuron, tribenuron-methyl, triflusulfuron, triflusulfuron-methyl, tritosulfuron, bencarbazone, flucarbazone, flucarbazone-sodium salt, propoxycarbazone, propoxycarbazone-sodium salt, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium salt, imazapic, imazapic-ammonium salt, imazapyr, imazapyr-isopropylammonium salt, imazaquin, imazaquin-ammonium salt, imazethapyr, and imazethapyr-ammonium salt, and agriculturally acceptable salts or derivatives thereof, and more preferably the group consisting of pyrithiobac, pyrithiobac-sodium salt, chlorimuron-ethyl, foramsulfuron, halosulfuron-methyl, nicosulfuron, primisulfuron-methyl, rimsulfuron, trifloxysulfuron-sodium salt, chlorsulfuron, iodosulfuron-methyl-sodium, iofensulfuron-sodium, mesosulfuron-methyl, prosulfuron, thifensulfuron-methyl, tribenuron-methyl, thiencarbazone-methyl, cloransulam-methyl, flumetsulam, imazamethabenz-methyl, imazamox-ammonium salt, imazapic-ammonium salt, imazapyr-isopropylammonium, imazaquin-ammonium salt, and imazethapyr-ammonium salt, and agriculturally acceptable salts or derivatives thereof.

B-2 is preferably the group consisting of clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-ethotyl, haloxyfop-methyl, haloxyfop-P, haloxyfop-P-ethotyl, haloxyfop-P-methyl, metamifop, propaquizafop, quizalofop, quizalofop-tefuryl, quizalofop-ethyl, quizalofop-P, quizalofop-P-tefuryl, quizalofop-P-ethyl, alloxydim, butroxydim, clethodim, cycloxydim, profoxydim, sethoxydim, tepraloxydim, tralkoxydim, and pinoxaden, and agriculturally acceptable salts or derivatives thereof, and more preferably the group consisting of fenoxaprop-ethyl, fenoxaprop-P-ethyl, fluazifop-butyl, fluazifop-P-butyl, quizalofop-ethyl, quizalofop-P-ethyl, clethodim, and sethoxydim, and agriculturally acceptable salts or derivatives thereof.

B-3 is preferably the group consisting of azafenidin, benzfendizone, oxadiazone, oxadiargyl, carfentrazone, carfentrazone-ethyl, saflufenacil, cinidon, cinidon-ethyl, sulfentrazone, pyraclonil, cyclopyranil, pyraflufen, pyraflufen-ethyl, butafenacil, fluazolate, fluthiacet, fluthiacet-methyl, flufenpyr, flufenpyr-ethyl, flumiclorac, flumiclorac-pentyl, flumioxazin, pentoxazone, oxyfluorfen, acifluorfen, acifluorfen-sodium salt, chlomethoxynil, chloronitrofen, nitrofen, bifenox, chlomethoxyfen, ethoxyfentyl, fluoroglycofen, fluoroglycofen-ethyl, fomesafen, fomesafen-sodium, halosafen, lactofen, tiafenacil, trifludimoxazin, thidiazimin, profluazole, and epyrifenacil, and agriculturally acceptable salts or derivatives thereof, and more preferably the group consisting of carfentrazone-ethyl, saflufenacil, sulfentrazone, pyraflufen-ethyl, fluthiacet-methyl, flufenpyr-ethyl, flumiclorac-pentyl, flumioxazin, oxyfluorfen, acifluorfen-sodium salt, fomesafen-sodium, lactofen, tiafenacil, trifludimoxazin, and epyrifenacil, and agriculturally acceptable salts or derivatives thereof.

B-4 is preferably the group consisting of benzobicyclon, bicyclopyrone, mesotrione, sulcotrione, tefuryltrione, tembotrione, isoxachlorotole, isoxaflutole, benzofenap, pyrasulfotole, pyrazolynate, pyrazoxyfen, fenquinotrione, topramezone, tolpyralate, lancotrione, lancotrione-sodium salt, 2-methyl-N-(5-methyl-1,3,4-oxadiazol-2-yl)-3-(methanesulfonyl)-4-(trifluoromethyl)benzamide (CAS registry No.: 1400904-50-8), 2-chloro-N-(1-methyl-1H-tetrazol-5-yl)-3-(methylthio)-4-(trifluoromethyl)benzamide (CAS registry No.: 1361139-71-0), 4-(4-fluorophenyl)-6-[(2-hydroxy-6-oxo-1-cyclohexen-1-yl)carbonyl]-2-methyl-1,2,4-triazine-3,5(2H,4H)-dione (CAS registry No.: 1353870-34-4), and 3-[(isopropylsulfonyl)methyl]-N-(5-methyl-1,3,4-oxadiazol-2-yl)-5-(trifluoromethyl)-1,2,4-triazolo[4,3-a]pyridine-8-carboxamide (CAS registry No.: 1994348-72-9), and agriculturally acceptable salts or derivatives thereof, and more preferably the group consisting of bicyclopyrone, mesotrione, tembotrione, isoxaflutole, fenquinotrione, topramezone, tolpyralate, lancotrione-sodium salt, 2-methyl-N-(5-methyl-1,3,4-oxadiazol-2-yl)-3-(methanesulfonyl)-4-(trifluoromethyl)benzamide (CAS registry No. 1400904-50-8), 2-chloro-N-(1-methyl-1H-tetrazol-5-yl)-3-(methylthio)-4-(trifluoromethyl)benzamide (CAS registry No. 1361139-71-0), and 4-(4-fluorophenyl)-6-[(2-hydroxy-6-oxo-1-cyclohexen-1-yl)carbonyl]-2-methyl-1,2,4-triazine-3,5(2H,4H)-dione (CAS registry No. 1353870-34-4), and agriculturally acceptable salts or derivatives thereof.

B-5 is preferably the group consisting of diflufenican, picolinafen, beflubutamid, norflurazon, fluridone, flurochloridone, and flurtamone, and agriculturally acceptable salts or derivatives thereof, and more preferably the group consisting of norflurazon and fluridone, and agriculturally acceptable salts or derivatives thereof.

B-6 is preferably the group consisting of ioxynil, ioxynil octanoate, bentazone, pyridafol, pyridate, bromophenoxym, bromoxynil, bromoxynil octanoate, chlorbromuron, chlorotoluron, chloroxuron, dimefuron, diuron, ethidimuron, fenuron, linuron, fluometuron, isoproturon, isouron, tebuthiuron, azuron, methabenzthiazuron, neburon, pentanochlor, propanil, metobromuron, metoxuron, monolinuron, siduron, simazine, atrazine, desmetryn, propazine, cyanazine, ametryn, simetryn, dimethametryn, prometon, prometryn, terbumeton, terbuthylazine, terbutryn, trietazine, hexazinone, metamitron, metribuzin, amicarbazone, bromacil, lenacil, terbacil, chloridazon, desmedipham, and phenmedipham, and agriculturally acceptable salts or derivatives thereof, and more preferably the group consisting of bentazone, bromoxynil octanoate, diuron, linuron, fluometuron, simazine, atrazine, ametryn, prometryn, and metribuzin, and agriculturally acceptable salts or derivatives thereof.

B-7 is preferably the group consisting of propachlor, metazachlor, alachlor, acetochlor, aridchlor, dimethachlor, metolachlor, S-metolachlor, butachlor, pretilachlor, propisochlor, thenylchlor, indanofan, cafenstrole, fentrazamide, diphenamid, dimethenamid, dimethenamid-P, dimepiperate, mefenacet, pyroxasulfone, fenoxasulfone, naproanilide, napropamide, napropamide M, pethoxamid, anilofos, piperofos, flufenacet, dimesulfazet, and ipfencarbazone, and agriculturally acceptable salts or derivatives thereof, and more preferably the group consisting of alachlor, acetochlor, metolachlor, S-metolachlor, dimethenamid, dimethenamid-P, pyroxasulfone, and flufenacet, and agriculturally acceptable salts or derivatives thereof.

B-8 is preferably the group consisting of trifluralin, pendimethalin, ethalfluralin, benfluralin, oryzalin, prodiamine, butamifos, dithiopyr, thiazopyr, amiprophos-methyl, carbetamide, chlorthal-dimethyl, butralin, dinitramine, propham, propyzamide, and tebutam, and agriculturally acceptable salts or derivatives thereof, and more preferably the group consisting of trifluralin, pendimethalin, and ethalfluralin, and agriculturally acceptable salts or derivatives thereof.

B-9 is preferably the group consisting of 2,3,6-TBA and a salt or ester thereof (dimethylammonium, lithium salt, potassium salt, sodium salt), 2,4-D and a salt or ester thereof (choline salt, tetrabutylammonium salt, biproamine, doboxyl, 2-ethylhexyl, 3-butoxypropyl, ammonium, butotyl, butyl, diethylammonium, dimethylammonium, diolamine salt, dodecylammonium, ethyl, heptylammonium, isobutyl, isooctyl, isopropyl, isopropylammonium, lithium salt, meptyl, methyl, octyl, pentyl, propyl, sodium salt, tefuryl, tetradecylammonium, triethylammonium, tris(2-hydroxypropyl)ammonium, and trolamine salt), 2,4-DB and a salt or ester thereof (choline salt, biproamine, butyl, dimethylammonium, isooctyl, potassium salt and sodium salt), MCPA and a salt or ester thereof (choline salt, biproamine, etexyl, butotyl, butyl, dimethylammonium, diolamine salt, ethyl, isobutyl, isooctyl, isopropyl, methyl, olamine salt, sodium salt and trolamine salt), MCPB and a salt or ester thereof (choline salt, biproamine, ethyl, methyl and sodium salt), mecoprop and a salt or ester thereof (choline salt, biproamine, 2-ethylhexyl, dimethylammonium, diolamine salt, ethadyl, isooctyl, methyl, potassium salt, sodium salt and trolamine salt), mecoprop-P and a salt or ester thereof (choline salt, 2-ethylhexyl, dimethylammonium, isobutyl, and potassium salt), dichlorprop and a salt or ester thereof (choline salt, biproamine, etexyl, butotyl, dimethylammonium, ethylammonium, isooctyl, methyl, potassium salt and sodium salt), dichlorprop-P and a salt or ester thereof (choline salt, biproamine, etexyl and dimethylammonium), dicamba and a salt or ester thereof (choline salt, biproamine, trolamine salt, diglycolamine salt, dimethylammonium, diolamine salt, isopropylammonium, methyl, olamine salt, potassium salt, sodium salt and tetrabutylammonium salt), triclopyr and a salt or ester thereof (butotyl, ethyl and triethylammonium), fluroxypyr and a salt or ester thereof (meptyl and butometyl), picloram and a salt thereof (potassium salt, tris(2-hydroxypropyl)ammonium salt and choline salt), quinclorac, quinmerac, aminopyralid and a salt thereof (choline salt, potassium salt and tripromine), clopyralid and a salt thereof (choline salt, methyl, olamine salt, potassium salt, tris(2-hydroxypropyl)ammonium, and triethylammonium salt), clomeprop, aminocyclopyrachlor and a salt thereof (methyl, potassium salt), halauxifen, halauxifen-methyl, florpyrauxifen, florpyrauxifen-benzyl, benazolin-ethyl, chloramben, 4-amino-3-chloro-5-fluoro-6-(7-fluoro-1H-indol-6-yl)pyridine-2-carboxylic acid, and 4-amino-3-chloro-5-fluoro-6-(7-fluoro-1H-indol-6-yl)pyridine-2-carboxylic cyanomethyl ester, and agriculturally acceptable salts or derivatives thereof, and more preferably the group consisting of 2,4-D, 2,4-D choline salt, 2,4-DB, dicamba, dicamba-biproamine, dicamba-diglycolamine salt, fluroxypyr, fluroxypyr-meptyl, clopyralid-olamine salt, clopyralid-potassium salt, clopyralid-triethylammonium salt, halauxifen, halauxifen-methyl, florpyrauxifen, and florpyrauxifen-benzyl, and agriculturally acceptable salts or derivatives thereof.

B-10 is preferably the group consisting of glyphosate, glyphosate choline salt, glyphosate-isopropylammonium, glyphosate biproamine, glyphosate-trimesium, glyphosate-ammonium salt, glyphosate-diammonium salt, glyphosate-dimethylammonium salt, glyphosate-monoethanolamine salt, glyphosate-sodium salt, glyphosate-potassium salt, and glyphosate-guanidine salt, and agriculturally acceptable salts or derivatives thereof, and more preferably the group consisting of glyphosate, glyphosate-isopropylammonium, glyphosate-ammonium salt, glyphosate-dimethylamine salt, glyphosate-monoethanolamine salt, glyphosate-potassium salt, and glyphosate-guanidine salt, and agriculturally acceptable salts or derivatives thereof.

B-11 is preferably the group consisting of glufosinate, glufosinate-ammonium salt, glufosinate-P, glufosinate-P-sodium salt, glufosinate-P-ammonium salt, and bialaphos, and agriculturally acceptable salts or derivatives thereof, and more preferably the group consisting of glufosinate, glufosinate-ammonium salt, glufosinate-P, and glufosinate-P-sodium salt, and agriculturally acceptable salts or derivatives thereof.

B-12 is preferably the group consisting of aclonifen, isoxaben, dichlobenil, thaxtomin A, methiozolin, diallate, butylate, triallate, chlorpropham, asulam, phenisopham, benthiocarb, molinate, esprocarb, pyributicarb, prosulfocarb, orbencarb, EPTC, dimepiperate, swep, difenoxuron, methyl daimuron, bromobutide, daimuron, cumyluron, diflufenzopyr, diflufenzopyr-sodium salt, naptalam, etobenzanid, tridiphane, amitrole, clomazone, bixlozone, maleic hydrazide, oxaziclomefone, cinmethylin, benfuresate, ACN, dalapon, chlorthiamid, flupoxam, bensulide, paraquat, paraquat-dichloride, diquat, diquat-dibromide, MSMA, indaziflam, triaziflam, tetflupyrolimet, dinoseb, dinoterb, DNOC, cycloate, ethofumesate, flupropanate, pebulate, TCA, TCA-ammonium, TCA-calcium, TCA-ethadyl, TCA-magnesium, TCA-sodium, tiocarbazil, vernolate, cyclopyrimorate, dazomet, difenzoquat, difenzoquat methyl sulphate, DSMA, flamprop M, flurenol, fosamine, metam, oleic acid, pelargonic acid, (2R,4R)-4-({[(5S)-3-(3,5-difluorofenyl)-5-vinyl-4,5-dihydroisoxazol-5-yl]carbonyl}amino)tetrahydrofuran-2-carboxylic methyl ester and (2S,4S)-4-({[(5R)-3-(3,5-difluorofenyl)-5-vinyl-4,5-dihydroisoxazol-5-yl]carbonyl}amino)tetrahydrofuran-2-carboxylic methyl ester, icafolin-methyl (CAS registry No.: 2749998-21-6), 1-{2-chloro-6-[(5-chloropyrimidin-2-yl)oxy]phenyl}-4,4,4-trifluorobutan-1-one (CAS registry No.: 2052297-97-7), and rimisoxafen (CAS registry No.: 1801862-02-01), and agriculturally acceptable salts or derivatives thereof, and more preferably the group consisting of EPTC, diflufenzopyr, diflufenzopyr-sodium salt, clomazone, bixlozone, cinmethylin, MSMA, paraquat, paraquat-dichloride, diquat, diquat-dibromide, tetflupyrolimet, and rimisoxafen, and agriculturally acceptable salts or derivatives thereof.

The present composition can further comprise one or more compounds selected from the safener group C (compound (C)).

The safener group C is preferably the group consisting of allidochlor, benoxacor, cloquintocet, cloquintocet-mexyl, cyometrinil, cyprosulfamide, dichlormid, dicyclonon, dietholate, dimepiperate, disulfoton, daimuron, fenchlorazole, fenchlorazole-ethyl, fenclorim, flurazole, fluxofenim, furilazole, hexym, isoxadifen, isoxadifen-ethyl, mecoprop, mefenpyr, mefenpyr-ethyl, mefenpyr-diethyl, mephenate, metcamifen, oxabetrinil, 1,8-naphthalic anhydride, 1,8-octa methylenediamine, AD-67 (4-(dichloroacetyl)-1-oxa-4-azaspiro [4.5] decane), R-29148 (3-(dichloroacetyl)-2,2,5-trimethyl-1,3-oxazolidine), CL-304415 (4-carboxy-3,4-dihydro-2H-1-benzopyran-4-acetic acid), CSB (1-bromo-4-[(chloromethyl)sulfonyl]benzene), DKA-24 (2,2-dichloro-N-[2-oxo-2-(2-propenylamino)ethyl]-N-(2-propenyl)acetamide), MG191 (2-(dichloromethyl)-2-methyl-1,3-dioxolane), MG-838 (2-propenyl 1-oxa-4-azaspiro[4.5]decane-4-carbodithioate), PPG-1292 (2,2-dichloro-N-(1,3-dioxan-2-ylmethyl)-N-(2-propenyl)acetamide), R-28725 (3-(dichloroacetyl)-2,2-dimethyl-1,3-oxazolidine), TI-35 (1-(dichloroacetyl)azepane), and N-(2-methoxybenzoyl)-4-[(methylaminocarbonyl)amino]benzenesulfon-amide, and agriculturally acceptable salts or derivatives thereof, and more preferably the group consisting of benoxacor, cyprosulfamide, and isoxadifen-ethyl, and agriculturally acceptable salts or derivatives thereof.

The present composition can further comprise carriers. For example, the present composition is a formulation prepared by mixing the compound (I), the compound (B), and the compound (C) used optionally with carriers such as a solid carrier and a liquid carrier, and adding auxiliary agents for formulation, such as a surfactant as necessary. The formulation type is preferably a suspension concentrate, an oil dispersion, a wettable powder, a water dispersible granule, a granule, an oil-in-water emulsion, a water-in-oil emulsion, and an emulsifiable concentrate. It may also be possible to use the present composition in combination with a formulation comprising other herbicides as active ingredients. It may also be possible to use a formulation comprising the compound (I) alone as an active ingredient in combination with a formulation comprising the compound (B) and the compound (C) used optionally as active ingredients.

The total content of the compound (I), the compound (B), and the compound (C) in the present composition is usually within a range of 0.01 to 90% by weight, and preferably 1 to 80% by weight.

Hereinafter, when the compound (B) is a salt (e.g., a glyphosate-potassium salt), its weight is represented by an acid equivalent. The mixing ratio by weight of the compound (I) to the compound (B) (the total of the compound (B) and the compound (C) when including the compound (C)) is usually within a range of 1:10\hat{ }15 to 10\hat{ }15:1.

The mixing ratio by weight of the compound (I) to the compound (B) (the total of the compound (B) and the compound (C) when including the compound (C)) is usually within a range of 1:10\hat{ }15 to 10\hat{ }15:1.

Examples of further preferable mixing ratio by weight or weight ratio of an application rate of the compound (I) to the compound (B) (the total of the compound (B) and the compound (C) when including the compound (C)) in the present composition and the present method include about 1:10\hat{ }15, 1:10\hat{ }14, 1:10\hat{ }13, 1:10\hat{ }12, 1:10\hat{ }11, 1:10\hat{ }10, 1:10\hat{ }9, 1:10\hat{ }8, 1:10\hat{ }7, 1:10\hat{ }6, 1:10\hat{ }5, 1:10000, 1:9000, 1:8000, 1:7000, 1:6000, 1:5000, 1:4000, 1:3000, 1:2000, 1:1000, 1:900, 1:800, 1:700, 1:600, 1:500, 1:400, 1:350, 1:300, 1:250, 1:200, 1:150, 1:100, 1:90, 1:80, 1:70, 1:60, 1:50, 1:40, 1:30, 1:20, 1:19, 1:18, 1:17, 1:16, 1:15, 1:14, 1:13, 1:12, 1:11, 1:10, 1:9, 1:8, 1:7, 1:6, 1:5, 2:9, 1:4, 2:7, 3:10, 1:3, 3:8, 2:5, 3:7, 4:9, 1:2, 5:9, 4:7, 3:5, 2:3, 5:7, 3:4, 7:9, 4:5, 5:6, 6:7, 7:8, 8:9, 1:1, 9:8, 8:7, 7:6, 6:5, 5:4, 9:7, 4:3, 7:5, 3:2, 5:3, 7:4, 9:5, 2:1, 9:4, 7:3, 5:2, 8:3, 3:1, 10:3, 7:2, 4:1, 9:2, 5:1, 6:1, 7:1, 8:1, 9:1, 10:1, 11:1, 12:1, 13:1, 14:1, 15:1, 16:1, 17:1, 18:1, 19:1, 20:1, 30:1, 40:1, 50:1, 60:1, 70:1, 80:1, 90:1, 100:1, 150:1, 200:1, 250:1, 300:1, 400:1, 500:1, 600:1, 700:1, 800:1, 900:1, 1000:1, 2000:1, 3000:1, 4000:1, 5000:1, 6000:1, 7000:1, 8000:1, 9000:1, 10000:1, 10\hat{ }5:1, 10\hat{ }6:1, 10\hat{ }7:1, 10\hat{ }8:1, 10\hat{ }9:1, 10\hat{ }10:1, 10\hat{ }11:1, 10\hat{ }12:1, 10\hat{ }13:1, 10\hat{ }14:1, and 10\hat{ }15:1.

“About” as used herein includes a range of a ratio increased or decreased by 10% by weight compared with a specified ratio. For example, about 1:2 includes a range of 1:1.8 to 1:2.2.

Examples of particularly preferable combination of the compound (I) and the compound (B) and a range of the weight ratio in the present composition and the present method are mentioned below, but are not limited thereto.
Combination of the compound (I) and pyrithiobac (1:0.1 to 1:20)
Combination of the compound (I) and pyrithiobac-sodium salt (1:0.1 to 1:20)
Combination of the compound (I) and chlorimuron-ethyl (1:0.1 to 1:20)
Combination of the compound (I) and foramsulfuron (1:0.1 to 1:20)
Combination of the compound (I) and halosulfuron-methyl (1:0.1 to 1:20) Combination of the compound (I) and nicosulfuron (1:0.1 to 1:20)
Combination of the compound (I) and primisulfuron-methyl (1:0.1 to 1:20)
Combination of the compound (I) and rimsulfuron (1:0.1 to 1:20)
Combination of the compound (I) and trifloxysulfuron-sodium salt (1:0.1 to 1:20) Combination of the compound (I) and chlorsulfuron (1:0.1 to 1:20)
Combination of the compound (I) and iodosulfuron-methyl-sodium (1:0.1 to 1:20)
Combination of the compound (I) and iofensulfuron-sodium (1:0.1 to 1:20) Combination of the compound (I) and mesosulfuron-methyl (1:0.1 to 1:20)
Combination of the compound (I) and prosulfuron (1:0.1 to 1:20)
Combination of the compound (I) and thifensulfuron-methyl (1:0.1 to 1:20) Combination of the compound (I) and tribenuron-methyl (1:0.1 to 1:20)
Combination of the compound (I) and thiencarbazone-methyl (1:0.1 to 1:20) Combination of the compound (I) and cloransulam-methyl (1:0.1 to 1:20)
Combination of the compound (I) and flumetsulam (1:0.1 to 1:20)
Combination of the compound (I) and imazamethabenz-methyl (1:0.1 to 1:20)
Combination of the compound (I) and imazamox-ammonium salt (1:0.1 to 1:20)
Combination of the compound (I) and imazapic-ammonium salt (1:0.1 to 1:20)
Combination of the compound (I) and imazapyr-isopropylammonium (1:0.1 to 1:20)
Combination of the compound (I) and imazaquin-ammonium salt (1:0.1 to 1:20)
Combination of the compound (I) and imazethapyr-ammonium salt (1:0.1 to 1:20)
Combination of the compound (I) and fenoxaprop-ethyl (1:0.1 to 1:20)
Combination of the compound (I) and fenoxaprop-P-ethyl (1:0.1 to 1:20)
Combination of the compound (I) and fluazifop-butyl (1:0.1 to 1:20)
Combination of the compound (I) and fluazifop-P-butyl (1:0.1 to 1:20)
Combination of the compound (I) and quizalofop-ethyl (1:0.1 to 1:20)
Combination of the compound (I) and quizalofop-P-ethyl (1:0.1 to 1:20)
Combination of the compound (I) and clethodim (1:0.1 to 1:20)
Combination of the compound (I) and sethoxydim (1:0.1 to 1:20)
Combination of the compound (I) and carfentrazone-ethyl (1:0.1 to 1:20)
Combination of the compound (I) and saflufenacil (1:0.1 to 1:20)
Combination of the compound (I) and sulfentrazone (1:0.1 to 1:30)
Combination of the compound (I) and pyraflufen-ethyl (1:0.1 to 1:30)
Combination of the compound (I) and fluthiacet-methyl (1:0.1 to 1:20)
Combination of the compound (I) and flufenpyr-ethyl (1:0.1 to 1:20)
Combination of the compound (I) and flumiclorac-pentyl (1:0.1 to 1:20)
Combination of the compound (I) and flumioxazin (1:0.1 to 1:20)
Combination of the compound (I) and oxyfluorfen (1:0.1 to 1:30)
Combination of the compound (I) and acifluorfen-sodium salt (1:0.1 to 1:30)
Combination of the compound (I) and fomesafen-sodium (1:0.1 to 1:30)
Combination of the compound (I) and lactofen (1:0.1 to 1:30) Combination of the compound (I) and tiafenacil (1:0.1 to 1:20)
Combination of the compound (I) and trifludimoxazin (1:0.1 to 1:20)
Combination of the compound (I) and epyrifenacil (1:0.1 to 1:20)
Combination of the compound (I) and bicyclopyrone (1:0.1 to 1:20)
Combination of the compound (I) and mesotrione (1:0.1 to 1:20)
Combination of the compound (I) and tembotrione (1:0.1 to 1:20)
Combination of the compound (I) and isoxaflutole (1:0.1 to 1:20)
Combination of the compound (I) and fenquinotrione (1:0.1 to 1:20)
Combination of the compound (I) and topramezone (1:0.1 to 1:20)
Combination of the compound (I) and tolpyralate (1:0.1 to 1:20)
Combination of the compound (I) and lancotrione-sodium salt (1:0.1 to 1:20)
Combination of the compound (I) and 2-methyl-N-(5-methyl-1,3,4-oxadiazol-2-yl)-3-(methanesulfonyl)-4-(trifluoromethyl)benzamide (CAS registry No. 1400904-50-8) (1:0.1 to 1:20)
Combination of the compound (I) and 2-chloro-N-(1-methyl-1H-tetrazol-5-yl)-3-(methylthio)-4-(trifluoromethyl)benzamide (CAS registry No. 1361139-71-0) (1:0.1 to 1:20)
Combination of the compound (2) and 4-(4-fluorophenyl)-6-[(2-hydroxy-6-oxo-1-cyclohexen-1-yl)carbonyl]-2-methyl-1,2,4-triazine-3,5(2H,4H)-dione (CAS registry No. 1353870-34-4) (1:0.1 to 1:20)
Combination of the compound (I) and norflurazon (1:0.1 to 1:20)
Combination of the compound (I) and fluridone (1:0.1 to 1:20)
Combination of the compound (I) and bentazone (1:1 to 1:50)
Combination of the compound (I) and bromoxynil octanoate (1:1 to 1:50)
Combination of the compound (I) and diuron (1:1 to 1:50)
Combination of the compound (I) and linuron (1:1 to 1:50)
Combination of the compound (I) and fluometuron (1:1 to 1:50)
Combination of the compound (I) and simazine (1:1 to 1:50)
Combination of the compound (I) and atrazine (1:1 to 1:50)
Combination of the compound (I) and ametryn (1:1 to 1:50)
Combination of the compound (I) and prometryn (1:1 to 1:50)
Combination of the compound (I) and metribuzin (1:1 to 1:50)
Combination of the compound (I) and alachlor (1:1 to 1:50)
Combination of the compound (I) and acetochlor (1:1 to 1:50)
Combination of the compound (I) and metolachlor (1:1 to 1:50)
Combination of the compound (I) and S-metolachlor (1:1 to 1:50)
Combination of the compound (I) and dimethenamid (1:1 to 1:50)
Combination of the compound (I) and dimethenamid-P (1:1 to 1:50)
Combination of the compound (I) and pyroxasulfone (1:0.1 to 1:20)
Combination of the compound (I) and flufenacet (1:0.1 to 1:20)
Combination of the compound (I) and trifluralin (1:1 to 1:50)
Combination of the compound (I) and pendimethalin (1:1 to 1:50)
Combination of the compound (I) and ethalfluralin (1:1 to 1:50)
Combination of the compound (I) and 2,4-D dimetylamine salt (1:1 to 1:50)
Combination of the compound (I) and 2,4-D choline salt (1:1 to 1:50)
Combination of the compound (I) and 2,4-D 2-ethylhexyl (1:1 to 1:50)
Combination of the compound (I) and dicamba (1:1 to 1:50)
Combination of the compound (I) and dicamba-biproamine (1:1 to 1:50)
Combination of the compound (I) and dicamba-diglycolamine salt (1:1 to 1:50)
Combination of the compound (I) and fluroxypyr (1:1 to 1:50)
Combination of the compound (I) and fluroxypyr-meptyl (1:1 to 1:50)
Combination of the compound (I) and clopyralid-olamine salt (1:1 to 1:50)
Combination of the compound (I) and clopyralid-potassium salt (1:1 to 1:50)
Combination of the compound (I) and clopyralid-triethylammonium salt (1:1 to 1:50) Combination of the compound (I) and halauxifen (1:0.1 to 1:20)
Combination of the compound (I) and halauxifen-methyl (1:0.1 to 1:20)
Combination of the compound (I) and florpyrauxifen (1:0.1 to 1:20)
Combination of the compound (I) and florpyrauxifen-benzyl (1:0.1 to 1:20)
Combination of the compound (I) and glyphosate (1:1 to 1:50)
Combination of the compound (I) and glyphosate-isopropylammonium (1:1 to 1:50)
Combination of the compound (I) and glyphosate-ammonium salt (1:1 to 1:50)
Combination of the compound (I) and glyphosate-dimethylamine salt (1:1 to 1:50)
Combination of the compound (I) and glyphosate-monoethanolamine salt (1:1 to 1:50)
Combination of the compound (I) and glyphosate-potassium salt (1:1 to 1:50)
Combination of the compound (I) and glyphosate-guanidine salt (1:1 to 1:50)
Combination of the compound (I) and glufosinate (1:1 to 1:50)
Combination of the compound (I) and glufosinate-ammonium salt (1:1 to 1:50)
Combination of the compound (I) and glufosinate-P (1:1 to 1:50)
Combination of the compound (I) and glufosinate-P-sodium salt (1:1 to 1:50)
Combination of the compound (I) and EPTC (1:1 to 1:50)
Combination of the compound (I) and diflufenzopyr (1:1 to 1:50)
Combination of the compound (I) and diflufenzopyr-sodium salt (1:1 to 1:50)
Combination of the compound (I) and clomazone (1:1 to 1:50)
Combination of the compound (I) and bixlozone (1:1 to 1:50)
Combination of the compound (I) and tetflupyrolimet (1:1 to 1:50)
Combination of the compound (I) and rimisoxafen (1:1 to 1:50)
Combination of the compound (I) and cinmethylin (1:1 to 1:50)
Combination of the compound (I) and MSMA (1:1 to 1:50)
Combination of the compound (I) and paraquat (1:1 to 1:50)
Combination of the compound (I) and paraquat-dichloride (1:1 to 1:50)
Combination of the compound (I) and diquat (1:1 to 1:50)
Combination of the compound (I) and diquat dibromide (1:1 to 1:50)

The mixing ratio by weight or weight ratio of an application rate of the compound (I) to the compound (C) in the present composition and the present method is preferably 1:0.1 to 1:20.

The present composition can exert a synergistic herbicidal effect on a broad range of weeds compared to the effect that is expected from the effect obtained when each one of the compound (I) and the compound (B) is applied alone, and can efficiently control a broad range of weeds in a crop field, a vegetable field, an orchard or a non-crop area, each where a normal tilled or non-tilled cropping is performed.

The present method can exert a synergistic herbicidal effect on a broad range of weeds compared to the effect that is expected from the effect obtained when each one of the compound (I) and the compound (B) is applied alone, and can efficiently control a broad range of weeds in a crop field, a vegetable field, an orchard or a non-crop area, each where a normal tilled or non-tilled cropping is performed.

The present composition, or the compound (I), the compound (B), and as necessary, the compound (C) may be applied to the agricultural field where crop seeds were seeded or will be seeded before, simultaneously with and/or after seeding the crop seeds applied with one or more compounds selected from the group consisting of insecticide compounds, nematicide compounds and fungicide compounds.

The present composition may be used in combination with other agrochemical active compounds. The insecticide compounds, the nematicide compounds and the fungicide compounds used in combination with the present composition include neonicotinoid-based compounds, diamide-based compounds, carbamate-based compounds, organophosphorus-based compounds, biological nematicide compounds, other insecticide compounds and nematicide compounds, as well as azole-based compounds, strobilurin-based compounds, metalaxyl-based compounds, SDHI compounds, and other fungicide compounds and plant growth regulators.

The crop field in the present invention may include a food crop field such as a peanut field, a soybean (indeterminate growth habit, determinate growth habit, semi-determinate growth habit) field, a corn (dent corn, flint corn, flour corn, popcorn, waxy corn, sweet corn, field corn) field and a wheat (bread wheat (soft wheat, hard wheat, medium wheat, red wheat, white wheat), durum wheat, spelt wheat, club wheat, and, winter habit and spring habit thereof) field, a barley (two-row barley, six-row barley, hulless barley, hulless waxy barley and, winter habit and spring habit thereof) field, a feed crop field such as a sorghum field and an oat field, an industrial crop field such as a cotton (upland cotton, pima cotton) field and a rapeseed field, a canola (winter habit, spring habit) field and sugar crops such as a sugarcane field and a sugar beet field.

The vegetable field in the present invention may include a field for cultivating solanaceae vegetables (eggplant, tomato, green pepper, chili pepper, potato, etc.), a field for cultivating cucurbitaceae vegetables (cucumber, pumpkin, zucchini, watermelon, melon, etc.), a field for cultivating cruciferous vegetables (radish, turnip, horseradish, kohlrabi, Chinese cabbage, cabbage, mustard, broccoli, cauliflower, etc.), a field for cultivating asteraceae vegetables (burdock, crown daisy, artichoke, lettuce, etc.), a field for cultivating liliaceae vegetables (welsh onion, onion, garlic, asparagus), a field for cultivating umbelliferae vegetables (carrot, parsley, celery, parsnip, etc.), a field for cultivating chenopodiaceae vegetables (spinach, chard, etc.), a field for cultivating lamiaceae vegetables (perilla, mint, basil, lavender), a strawberry field, a sweet potato field, a yam field, an taro field and the like.

The orchard area in the present invention may include an orchard, a tea field, a mulberry field, a coffee field, a banana field, a palm field, a flowering tree farm, a flowering tree field, a planting stock field, a nursery field, a forest land, or a garden. The orchard tree in the present invention may include pome fruits (apple, pear, Japanese pear, Chinese quince, quince, etc.), stone fruits (peach, plum, nectarine, Japanese apricot, yellow peach, apricot, prune, etc.), citrus fruits (citrus unshiu, orange, lemon, lime, grapefruit, etc.), nut trees (chestnut, walnut, hazelnut, almond, pistachio, cashew nut, macadamia nut, etc.), berry fruits (grape, blueberry, cranberry, blackberry, raspberry, etc.), persimmon, olive, loquat and the like.

The non-crop area in the present invention may include an athletic field, an empty lot, a railroad edge, a park, a parking area, a road edge, a dry riverbed, under power lines, a building land, a factory site and the like.

The crops cultivated in a crop field in the present invention is performed is not limited as long as their varieties are varieties which are usually cultivated as crops.

The plant of the variety mentioned above may be a plant which can be produced by natural hybridization, a plant which can occur as the result of a mutation, an F1 hybrid plant, or a transgenic plant (also referred to as a “genetically modified plant”). These plants generally have properties such as a property that the tolerance to a herbicide is imparted, a property that a toxic substance against pests is accumulated, a property that the sensitivity to a plant disease is suppressed, a property that yield potential is increased, a property that the resistance to a biological or non-biological stress factor is improved, a property that a substance is accumulated, and improvement in a storage property or processability.

The term “F1 hybrid plant” refers to a plant of a first filial generation which is produced by hybridizing two different varieties with each other, and is generally a plant which has a more superior trait to that of either one of parents thereof, i.e., has a hybrid vigor property. The term “transgenic plant” refers to a plant which is produced by introducing a foreign gene from another organism such as a microorganism into a plant and which has a property that cannot be acquired easily by hybridization breeding, induction of a mutation or a naturally occurring recombination under a natural environment.

Examples of the technique for producing the above-mentioned plants include a conventional breeding technique, a transgenic technique, a genome-based breeding technique, a new breeding technique, and a genome editing technique. The conventional breeding technique is a technique for producing a plant having a desirable property by mutation or hybridization. The transgenic technique is a technique for imparting a new property to a specific organism (e.g., a microorganism) by isolating a gene (DNA) of interest from the organism and then introducing the gene (DNA) into the genome of another target organism, and an antisense technique or an RNA interference technique which is a technique for imparting a new or improved property to a plant by silencing another gene occurring in the plant. The genome-based breeding technique is a technique for increasing the efficiency of breeding using genomic information, and includes a DNA marker (also referred to as “genome marker” or “gene marker”) breeding technique and genomic selection. For example, the DNA marker breeding is a method in which an offspring having a desired useful trait gene is selected from many hybrid offsprings using a DNA marker that is a DNA sequence capable of serving as an indicator of the position of a specific useful trait gene on a genome. The analysis of a hybrid offspring of a plant at a seedling stage thereof using the DNA marker has such a characteristic that it becomes possible to shorten the time required for breeding effectively.

The genomic selection is such a technique that a prediction equation is produced from a phenotype and genomic information both obtained in advance and then a property is predicted from the prediction equation and the genomic information without carrying out the evaluation of the phenotype. The genomic selection can contribute to the increase in efficiency of breeding. A “new breeding technique” is a collective term for combinations of breeding techniques including molecular biological techniques. Examples of the new breeding technique include techniques such as cisgenesis/intragenesis, oligonucleotide-directed mutagenesis, RNA-dependent DNA methylation, genome editing, grafting to a GM rootstock or scion, reverse breeding, agroinfiltration, and seed production technology (SPT). The genome editing technique is a technique that converts genetic information in a sequence-specific manner, and enables deletion of a base sequence, substitution of an amino acid sequence, introduction of a foreign gene and the like. Examples of the tool for the technique include zinc-finger nuclease (ZFN), TALEN, CRISPR/Cas9, CRISPR/Cpf1 and meganuclease which can cleave DNA in a sequence-specific manner, and a sequence-specific genome modification technique using CAS9 nickase, Target-AID and the like which is produced by any one of the modification of the above-mentioned tools.

Examples of the above-mentioned plants include plants listed in genetically modified crops registration database (GM APPROVAL DATABASE) in an electric information site in INTERNATIONAL SERVICE for the ACQUISITION of AGRI-BIOTECH APPLICATIONS, ISAAA) (http://www.isaaa.org/). More specific examples of the plans include a herbicide-tolerant plant, a pest-resistant plant, a plant disease-resistant plant, a plant of which the quality (e.g., the increase or decrease in content or the change in composition) of a product (e.g., starch, amino acid, fatty acid, etc.) is modified, a fertility trait modified plant, a non-biological stress-tolerant plant or a plant of which a trait associated with growth or yield is modified.

The plant imparted with tolerance to a herbicide by a transgenic technique also includes plants each, by a transgenic technique, imparted with the tolerance to: a 4-hydroxyphenylpyruvate dioxygenase (hereinafter abbreviated as “HPPD”) inhibitor such as isoxaflutole and mesotrione; an acetolactate synthase (hereinafter abbreviated as “ALS”) inhibitor such as an imidazolinone-type herbicide including imazethapyr and a sulfonylurea-type herbicide including thifensulfuron-methyl; a 5-enolpyruvylshikimate-3-phosphate synthase (hereinafter abbreviated as “EPSP”) inhibitor such as glyphosate; a glutamine synthase inhibitor such as glufosinate; an auxin-type herbicide such as 2,4-D and dicamba; and an oxynil-type herbicide including bromoxynil. Preferred examples of the herbicide-tolerant transgenic plant include: a cereal such as wheat, barley, rye and oat; canola, sorghum, soybean, rice, rapeseed, sugar beet, sugarcane, grape, lentil, sunflower, alfalfa, a pomaceous fruit, a stone fruit, coffee, tea, strawberry, wheat grass, and a vegetable such as tomato, potato, cucumber and lettuce; more preferably a cereal such as wheat, barley, rye and oat, soybean, rice, vine, tomato, potato, and a pomaceous fruit.

Hereinbelow, specific examples of the herbicide-tolerant plant will be mentioned.

Plants tolerant to glyphosate herbicides; produced by introducing at least one of a glyphosate-tolerant EPSPS gene originated from Agrobacterium tumefaciens strain CP4 (CP4 epsps), a glyphosate-metabolizing enzyme gene in which metabolic activity is enhanced by a shuffling technique for a glyphosate-metabolizing enzyme (glyphosate N-acetyltransferase) gene originated from Bacillus licheniformis (gat4601, gat4621), a glyphosate-metabolizing enzyme originated from Ochrobacterum anthropi strain LBAA (glyphosate oxidase gene, goxv247) or an EPSPS gene originated from corn and having a glyphosate tolerance mutation (mepsps, 2mepsps). Examples of the major plant include alfalfa (Medicago sativa), Argentina canola (Brassica napus), cotton (Gossypium hirsutum L.), creeping bentgrass (Agrostis stolonifera), corn (Zea mays L.), polish canola (Brassica rapa), potato (Solanum tuberosum L.), soybean (Glycine max L.), sugar beet (Beta vulgaris) and wheat (Triticum aestivum). Some of the glyphosate-tolerant transgenic plants are commercially available. For example, a genetically modified plant which expresses glyphosate-tolerant EPSPS originated from Agrobacterium is commercially available by trade names including the trademark of “Roundup Ready (registered trademark)”; a genetically modified plant which expresses a glyphosate-metabolizing enzyme originated from Bacillus in which metabolic activity is enhanced by a shuffling technique is commercially available by the trade names of “Optimum (registered trademark) GAT (trademark)”, “Optimum (registered trademark) Gly canola” and the like; and a genetically modified plant which expresses EPSPS having a glyphosate tolerance mutation originated from corn is commercially available by the trademark of “GlyTol (trademark)”.

Plants tolerant to glyfosinate herbicides; produced by introducing at least one of a gene (bar) for phosphinothricin N-acetyltransferase (PAT) which is a glufosinate-metabolizing enzyme originated from Streptomyces hygroscopicus, a gene (pat) for a phosphinothricin N-acetyltransferase (PAT) enzyme which is a glufosinate-metabolizing enzyme originated from Streptomyces viridochromogenes or a synthetic pat gene (pat syn) originated from Streptomyces viridochromogenes strain Tu494. Examples of the major plant include Argentina canola (Brassica napus), chicory (Cichorium intybus), cotton (Gossypium hirsutum L.), corn (Zea mays L.), polish canola (Brassica rapa), rice (Oryza sativa L.), soybean (Glycine max L.) and sugar beet (Beta vulgaris). Some of the glufosinate-tolerant genetically modified plants are commercially available. The glufosinate-metabolizing enzyme (bar) originated from Streptomyces hygroscopicus and a genetically modified plant originated from Streptomyces viridochromogenes are commercially available by the trade names including “LibertyLink (trademark)”, “InVigor (trademark)” and “WideStrike (trademark)”.

Plants tolerant to oxynil-type herbicides (e.g., bromoxynil); includes transgenic plants tolerant to oxynil-type herbicides, for example, bromoxynil, into which a nitrilase gene (bxn) which is an oxynil-type herbicide (e.g., bromoxynil)-metabolizing enzyme originated from Klebsiella pneumoniae subsp. Examples of the major plant include Argentina Canola (Brassica napus), cotton (Gossypium hirsutum L.) and tobacco (Nicotiana tabacum L.), which are commercially available by the trade names including “Navigator (trademark) canola” or “BXN (trademark)”.

Plants tolerant to ALS inhibitors; carnation (Dianthus caryophyllus) having, introduced therein, an ALS inhibitor-tolerant ALS gene (surB) originated from tobacco (Nicotiana tabacum) as a selection marker is commercially available by the trade names of “Moondust (trademark)”, “Moonshadow (trademark)”, “Moonshade (trademark)”, “Moonlite (trademark)”, “Moonaqua (trademark)”, Moonvista (trademark)”, “Moonique (trademark)”, “Moonpearl (trademark)”, “Moonberry (trademark)” and “Moonvelvet (trademark)”; lineseed (Linum usitatissumum L.) having, introduced therein, an ALS inhibitor-tolerant ALS gene (als) originated from mouse-ear cress (Arabidopsis thaliana) is commercially available by the trademark of “CDC Triffid Flax”; corn (Zea mays L.) having tolerance to a sulfonylurea-type herbicide and an imidazolinone-type herbicide and having, introduced therein, an ALS inhibitor-tolerant ALS gene (zm-hra) originated from corn is commercially available by the trademark of “Optimum (trademark) GAT (trademark)”; soybean having tolerance to an imidazolinone-type herbicide and having, introduced therein, an ALS inhibitor-tolerant ALS gene (csr1-2) originated from mouse-ear cress is commercially available by the trademark of “Cultivance”; and soybean having tolerance to a sulfonylurea-type herbicide and having, introduced therein, an ALS inhibitor-tolerant ALS gene (gm-hra) originated from soybean (Glycine max) is commercially available by the trade names of “Treus (trademark)”, “Plenish (trademark)” and “Optimum GAT (trademark)”. Cotton having, introduced therein, an ALS inhibitor-tolerant ALS gene (S4-HrA) originated from tobacco (Nicotiana tabacum cv. Xanthi) can also be mentioned.

Plants tolerant to HPPD inhibitors; soybean into which both a mesotrione-tolerant HPPD gene (avhppd-03) originated from oat (Avena sativa) and a gene (pat) for a phosphinothricin N-acetyltransferase (PAT) enzyme which is a glufosinate-metabolizing enzyme originated from Streptomyces viridochromogenes are introduced is commercially available by the trademark of “Herbicide-tolerant Soybean line”.

Plants tolerant to 2,4-D; corn having, introduced therein, an aryloxyalkanoate dioxygenase gene (aad-1) which is a 2,4-D-metabolizing enzyme originated from Sphingobium herbicidovorans is commercially available by the trademark of “Enlist (trademark) Maize”. Soybean and cotton having, introduced therein, an aryloxyalkanoate dioxygenase gene (aad-12) which is a 2,4-D-metabolizing enzyme originated from Delftia acidovorans are commercially available by the trademark of “Enlist (trademark) Soybean”.

Plants tolerant to dicamba; includes soybean and cotton having, introduced therein, a dicamba monooxygenase gene (dmo) which is a dicamba-metabolizing enzyme originated from Stenotrophomonas maltophilia strain DI-6. Soybean (Glycine max L.) into which a glyphosate-tolerant EPSPS gene (CP4 epsps) originated from Agrobacterium tumefaciens strain CP4 is also introduced simultaneously with the above-mentioned gene is commercially available as “Genuity (registered trademark) Roundup Ready (trademark) 2 Xtend (trademark)”.

Examples of a commercially available transgenic plant imparted with tolerance to herbicides include corn “Roundup Ready Corn”, “Roundup Ready 2”, “Agrisure GT”, “Agrisure GT/CB/LL”, “Agrisure GT/RW”, “Agrisure 3000GT”, “YieldGard VT Rootworm/RR2” and “YieldGard VT Triple” each having tolerance to glyphosate; soybean “Roundup Ready Soybean” and “Optimum GAT” each having tolerance to glyphosate; cotton “Roundup Ready Cootton” and “Roundup Ready Flex” each having tolerance to glyphosate; canola “Roundup Ready Canola” having tolerance to glyphosate; alfalfa “Roundup Ready Alfalfa” having tolerance to glyphosate and rice “Roundup Ready Rice” having tolerance to glyphosate; corn “Roundup Ready 2”, “Liberty Link”, “Herculex 1”, “Herculex RW”, “Herculex Xtra”, “Agrisure GT/CB/LL”, “Agrisure CB/LL/RW” and “Bt10” each having tolerance to glufosinate; cotton “FiberMax Liberty Link” having tolerance to glufosinate; rice “Liberty Link Rice” having tolerance to glufosinate; canola “in Vigor” having tolerance to glufosinate; cotton “BXN” having tolerance to bromoxynil; and canola “Navigator” and “Compass” having tolerance to bromoxynil. Other plants which are modified with respect to herbicides are also widely known, such as: alfalfa, apple, barley, eucalyptus, lineseed, grape, lentil, rapeseed, pea, potato, rice, sugar beet, sunflower, tobacco, tomato, turf grass and wheat each having tolerance to glyphosate (see, for example, U.S. Pat. Nos. 5,188,642, 4,940,835, 5,633,435, 5,804,425 and 5,627,061); bean, cotton, soybean, pea, potato, sunflower, tomato, tobacco, corn, sorghum and sugarcane each having tolerance to dicamba (see, for example, WO 2008051633, U.S. Pat. Nos. 7,105,724 and 5,670,454); soybean, sugar beet, potato, tomato and tobacco each having tolerance to glufosinate (see, for example, U.S. Pat. Nos. 6,376,754, 5,646,024 and 5,561,236); cotton, peppers, apple, tomato, sunflower, tobacco, potato, corn, cucumber, wheat, soybean, sorghum and millets each having tolerance to 2,4-D (see, for example, U.S. Pat. Nos. 6,153,401, 6,100,446, WO 2005107437, U.S. Pat. Nos. 5,608,147 and 5,670,454); canola, corn, barnyard millet, barley, cotton, brown mustard, lettuce, lentil, melon, foxtail millet, oat, rapeseed, potato, rice, rye, sorghum, soybean, sugar beet, sunflower, tobacco, tomato and wheat each having tolerance to an ALS inhibitor (e.g., a sulfonylurea-type herbicide and an imidazolinone-type herbicide) (see, for example, U.S. Pat. No. 5,013,659, WO 2006060634, U.S. Pat. Nos. 4,761,373, 5,304,732, 6,211,438, 6,211,439 and 6,222,100) (particularly, rice having tolerance to an imidazolinone-type herbicide; rice having a specific mutation (e.g., S653N, S654K, A122T, S653 (At) N, S654 (At) K, A122 (At) T) in an acetolactate synthase gene (acetohydroxyacid synthase gene) and the like (see, for example, US 2003/0217381, WO 2005/20673)); barley, sugarcane, rice, corn, tobacco, soybean, cotton, rapeseed, sugar beet, wheat and potato each having tolerance to an HPPD inhibitor (e.g., an isoxazole-type herbicide such as isoxaflutole; a triketone-type herbicide such as sulcotrione and mesotrione; a pyrazole-type herbicide such as pyrazolynate and diketonitrile that is a decomposition product of isoxaflutole) (see, for example, WO 2004/055191, WO 199638567, WO 1997049816 and U.S. Pat. No. 6,791,014).

Examples of a plant that is imparted with tolerance to a herbicide by a classical breeding technique or genome-based breeding technique include: rice “Clearfield Rice”, wheat “Clearfield Wheat”, sunflower “Clearfield Sunflower”, lentil “Clearfield lentils” and canola “Clearfield canola” (a product by manufactured by BASF) each having tolerance to an imidazolinone-type ALS inhibitor such as imazethapyr and imazamox; soybean “STS soybean” having tolerance to a sulfonylurea-type ALS inhibitor such as thifensulfuron-methyl; sethoxydim-tolerant corn “SR corn” and “Poast Protected (registered trademark) corn” having tolerance to an acetyl CoA carboxylase inhibitor such as a trione oxime-type herbicide and an aryloxyphenoxypropionate-type herbicide; for example, sunflower “ExpressSun (registered trademark)” having tolerance to a sulfonylurea-type herbicide such as tribenuron; rice “Rrovisia (trademark) Rice” having tolerance to an acetyl CoA carboxylase inhibitor such as quizalofop; canola “Triazine Tolerant Canola” having tolerance to a PSII inhibitor.

An example of a plant that is imparted with tolerance to a herbicide by a genome editing technique is canola “SU Canola (registered trademark)” having tolerance to a sulfonylurea-type herbicide and produced by Rapid Trait Development System (RTDS (registered trademark)). RTDS (registered trademark) corresponds to an oligonucleotide-directed mutagenesis employed in a genome editing technique, and is a technique whereby it becomes possible to introduce a mutation into a plant through Gene Repair Oligonucleotide (GRON), i.e., a DNA-RNA chimeric oligonucleotide, without needing to cleave DNA in the plant. Other examples of the plant also include: corn which is reduced in herbicide tolerance and a phytic acid content as the result of the deletion of endogenous gene IPK1 using a zinc finger nuclease (see, for example, Nature 459, 437-441 2009); and rice which is imparted with herbicide tolerance using CRISPR/Cas9 (see, for example, Rice, 7, 5 2014).

The crop tolerant to a specific PPO inhibitor in the present invention includes a crop which is imparted with ability to produce PPO with decreased affinity to the PPO inhibitor by a transgenic technique and a crop which is imparted with ability to detoxicate/decompose the PPO inhibitor by cytochrome P450 monooxygenase by a transgenic technique. The crop tolerant to a specific PPO inhibitor may be a crop which is imparted with both ability to produce PPO with decreased affinity to the PPO inhibitor and ability to detoxicate/decompose the PPO inhibitor by cytochrome P450 monooxygenase by a transgenic technique. These tolerant crops are mentioned in, for example, Patent Documents such as WO 2011085221, WO 2012080975, WO 2014030090, WO 2015022640, WO 2015022636, WO 2015022639, WO 2015092706, WO 2016203377, WO 2017198859, WO 2018019860, WO 2018022777, WO 2017112589, WO 2017087672, WO 2017039969, WO 2017023778, WO 2018022777, WO 2019118726 and Non-Patent Document (Pest Management Science, 61, 2005, 277-285).

The technique imparting tolerance to a herbicide by a new breeding technique includes a breeding technique employing grafting, and as an example of imparting a trait of a GM rootstock to a scion, soybean in which tolerance to glyphosate is imparted to a non-transgenic soybean scion using Roundup Ready (registered trademark) soybean having tolerance to glyphosate as a rootstock (see Weed Technology 27:412-416 2013) can be mentioned.

The plants mentioned above also include a line imparted with two or more of tolerance to non-biological stress, plant disease resistance, tolerance to herbicides, pest resistance, growth or yield trait, nutrient uptake, quality of a product, fertility trait and the like as previously mentioned, using a transgenic technique, a classical breeding technique, a genome-based breeding technique, a new breeding technique or genome editing technique or the like, and a line imparted with two or more properties of a parental line by crossing plants of the same kind or having different properties.

Examples of a commercially available plant imparted with tolerance to two or more herbicides include: cotton “GlyTol (trademark) LibertyLink (trademark)” and “GlyTol (trademark) LibertyLink (trademark)” each having tolerance to glyphosate and glufosinate; corn “Roundup Ready (trademark) LibertyLink (trademark) Maize” having tolerance to glyphosate and tolerance to glufosinate; soybean “Enlist (trademark) Soybean” having tolerance to glufosinate and tolerance to 2,4-D; soybean “Genuity (registered trademark) Roundup Ready (trademark) 2 Xtend (trademark)” having tolerance to glyphosate and tolerance to dicamba; corn and soybean “OptimumGAT (trademark)” having tolerance to glyphosate and tolerance to an ALS inhibitor; genetically modified soybean “Enlist E3 (trademark)” and “Enlist (trademark) Roundup Ready 2 Yield (registered trademark)” each having tolerance to three herbicides of glyphosate, glufosinate and 2,4-D; genetically modified corn “Enlist (trademark) Roundup Ready (registered trademark) Corn 2” having tolerance to glyphosate, 2,4-D and aryloxyphenoxypropionate-type (FOPs) herbicides; genetically modified corn “Enlist (trademark) Roundup Ready (registered trademark) Corn 2” having tolerance to glyphosate, 2,4-D and aryloxyphenoxypropionate-type (FOPs) herbicides; genetically modified cotton “Bollgard II (registered trademark) XtendFlex (trademark) Cotton” having tolerance to dicamba, glyphosate and glufosinate; and genetically modified cotton “Enlist (trademark) Cotton” having tolerance to three herbicides of glyphosate, glufosinate and 2,4-D. In addition, the following plants are also developed: cotton having tolerance to glufosinate and 2,4-D; cotton having tolerance to both glufosinate and dicamba; corn having tolerance to both glyphosate and 2,4-D; soybean having tolerance to both glyphosate and an HPPD herbicide; and genetically modified corn having tolerance to glyphosate, glufosinate, 2,4-D, aryloxyphenoxypropionate-type (FOPs) herbicides and cyclohexadione-type (DIMs) herbicides.

Examples of a commercially available plant imparted with tolerance to herbicides and pest resistance include: corn “YieldGard Roundup Ready” and “YieldGard Roundup Ready 2” each having tolerance to glyphosate and resistance to corn borer; corn “Agrisure CB/LL” having tolerance to glufosinate and resistance to corn borer; corn “Yield Gard VT Root worm/RR2” having tolerance to glyphosate and resistance to corn rootworm; corn “Yield Gard VT Triple” having tolerance to glyphosate and resistance to corn rootworm and corn borer; corn “Herculex I” having tolerance to glufosinate and resistance to a lepidopteran pest (Cry1F) (e.g., resistance to western bean cutworm, corn borer, black cutworm and fall armyworm); corn “YieldGard Corn Rootworm/Roundup Ready 2” having tolerance to glyphosate and resistance to corn rootworm; corn “Agrisure GT/RW” having tolerance to glufosinate and resistance to a coleopteran pest for corn (Cry3A) (e.g., resistance to Western corn rootworm, Northern corn rootworm and Mexican corn rootworm); corn “Herculex RW” having tolerance to glufosinate and resistance to a coleopteran pest (Cry34/35Ab1) (e.g., resistance to Western corn rootworm, Northern corn rootworm and Mexican corn rootworm); corn “Yield Gard VT Root worm/RR2” having tolerance to glyphosate and resistance to corn rootworm; and cotton “Bollgard 3 (registered trademark) XtendFlex (registered trademark)” having tolerance to dicamba, tolerance to glyphosate, tolerance to glyfosinate and resistance to a lepidopteran pest (e.g., resistance to ballworms and tobacco budworm, armyworms and the like).

The type of the nozzle to be used in the application of the compound (I), the compound (B), and the compound (C) used as necessary in the present method may be a flat fan nozzle or a drift-reducing nozzle. Examples of the flat fan nozzle include products of Teejet 110 series and XR Teejet 110 series manufactured by Teejet. The volume median diameter of liquid droplets ejected through each of the nozzles is usually less than 430 microns at an ordinary spraying pressure, usually 30 to 120 PSI. A drift-reducing nozzle is a nozzle reduced in drift compared with a flat fan nozzle and is called as “air induction nozzle” or “pre-orifice nozzle”. The volume median diameter of liquid droplets ejected through the drift-reducing nozzle is usually 430 microns or more.

An air induction nozzle has an air guide part between an inlet (spray liquid introduction part) of the nozzle and an outlet (spray liquid ejection part) of the nozzle, so that liquid droplets filled with air can be formed upon the mixing the spray liquid with air. Examples of the air induction nozzle include: TDXL11003-D, TDXL11004-D1, TDXL11005-D1 and TDXL11006-D manufactured by Green Leaf Technology; TTI110025, TTI11003, TTI11004, TTI11005, TTI11006 and TTI11008 manufactured by Teejet; and ULD120-041, ULD120-051 and ULD120-061 manufactured by Pentair. A particularly desirable one is TTI11004.

A pre-orifice nozzle is a nozzle in which an inlet (a spray liquid introduction part) of the nozzle serves as a metering orifice, so that large liquid droplets can be formed by controlling the flow amount to be flown into the nozzle so as to decrease the pressure in the nozzle. When the pre-orifice nozzle is used, the pressure during the ejection of the spray liquid can be reduced by half compared with the pressure before the introduction of the spray liquid. Examples of the pre-orifice nozzle include: DR110-10, UR110-05, UR110-06, UR110-08 and UR110-10 manufactured by Wilger; and 1/4TTJ08 Turf Jet and 1/4TTJ04 Turf Jet manufactured by Teejet.

The sprayer used to apply the compound (I), the compound (B), and the compound (C) used as necessary in the present method may be a hooded sprayer certified by the U.S. Environmental Protection Agency (EPA) as drift reduction technology (DRT). Examples of the hooded sprayer with DRT certification include REDBALL 642, REDBALL 642E, REDBALL SPK645, REDBALL 645, REDBALL 645T, REDBALL SP645, REDBALL ATV642, and the like of Willmar Fabrication LLC.

When the compound (I), the compound (B), and as necessary, the compound (C) are applied on a crop field, the compound (I), the compound (B), and the compound (C) as necessary may be applied before seeding crop seeds, and the compound (I), the compound (B), and as necessary, the compound (C) may be applied simultaneously with and/or after seeding crop seeds.

Namely, the compound (I), the compound (B), and the compound (C) used as necessary are applied once before, simultaneously with, or after seeding crop seeds; twice except before seeding crop seeds, twice except simultaneously with seeding, or twice except after seeding crop seeds; or three times before, simultaneously with, and after seeding.

When the compound (I), the compound (B), and as necessary, the compound (C) are applied before seeding crop seeds, the compound (I), the compound (B), and as necessary, the compound (C) are usually applied 50 days before seeding to immediately before seeding, preferably 30 days before seeding to immediately before seeding, more preferably 20 days before seeding to immediately before seeding, and still more preferably 10 days before seeding to immediately before seeding.

When the compound (I), the compound (B), and as necessary, the compound (C) are applied after seeding crop seeds, the compound (I), the compound (B), and as necessary, the compound (C) are usually applied immediately after seeding to before flowering. More preferable application timing is between immediately after seeding and before emergence, or between the 1 leaf stage and the 6 leaf stage of the true leaf of the crop.

When the compound (I), the compound (B), and the compound (C) as necessary are applied simultaneously with seeding the crop seeds, the machine to be used is a machine in which a sowing machine and a spraying machine are integrated with each other.

Examples of application timing for weeds include a foliage application for growing weeds or a soil application for the place where weeds may grow. When the place where weeds are growing is also the place where weeds may grow, a foliage application and a soil application can be performed. The application timing for weeds is independent of the application timing for crops, for example, the foliage application for weeds is sometimes performed before sowing crops, or the soil application for weeds is sometimes performed during crop growth. The application for weeds can be performed uniformly in an area-wide manner to the land, or can be a spot application.

In the method of the present invention, the spot application is the concept opposed to uniformly applying with a herbicide in an area-wide manner, and means an application in which the herbicide is selectively sprayed on the place where weeds are growing or may grow. The term “application for place” means an application for weeds or soil if weeds are growing, or an application for soil at the place where weeds may grow. The case where, the compound (I), the compound (B), and as necessary, the compound (C) are slightly sprayed on the place where weeds are not growing or may not grow by scattering or transpiration, is also included in the spot application unless it is a uniform and area-wide application. Only the case where, all the places where weeds are growing or may grow are selectively applied in a continuous cultivation field of crops, is not considered as the spot application. In other words, even if a part of the cultivation field is applied in an area-wide manner, or a part of the place where weeds are growing or may grow is not applied with the compound (I), the compound (B), and as necessary, the compound (C), the application is included in the spot application if a spot-applied place is present in the continuous cultivation field of crops. The spot application can be performed while avoiding crops, or can be applied based only on the location of weeds, independent of the location of crops.

Specific examples of the method for spot application are shown below. The spot application can be performed as follows: in the cultivation field of crops, a spraying person visually apply the compound (I), the compound (B), and as necessary, the compound (C) using a handheld nozzle or a robotic arm nozzle while walking or riding on a device running on the ground or a flying device. The spot application can also be performed by mapping the place where weeds are growing or may grow in advance, and applying the compound (I), the compound (B), and as necessary, the compound (C) based on map information. In application based on map information, the spot application can be performed by, in addition to the above method, automatically or manually opening and closing the nozzle on the boom or the robotic arm nozzle while running or flying of a spraying machine, based on location information of the spraying machine (obtained by GPS) and the map information. The map information can be created based on image information taken by a manned or unmanned flying object, or the map information can be created visually by an observer walking on the ground, an observer riding on a device running on the ground, or an observer riding on a flying device. Furthermore, the running or flying spraying machine has a function to detect the place where weeds are growing or may grow, and the spot application can be performed by the boom or robotic arm while performing real-time mapping. These technologies are mentioned in Patent Documents (e.g., WO 2018001893, WO 2018036909) and Non-Patent Documents (e.g., Crop Protection 26, 270-277, Weed Technology 17, 711-717, Applied Engineering in Agriculture. 30, 143-152). These technologies correspond to a form of emerging agriculture called precision agriculture, smart agriculture or digital agriculture, and the non-uniform spray style generated by the spot application is also called variable rate application (VRA) as the term in the emerging agriculture. The technology in which a running spraying machine performs the spot application in real time while detecting weeds which will grow is also known as “See & Spray” or “optical spot spray technology (OSST)”.

The place where weeds may grow can be estimated based on the fact that the weeds formed a vegetation batch in the past growing season, or it can be estimated from the distribution of buried seeds. The distribution of buried seeds can be examined by soil sampling or estimated by remote sensing.

Specific examples of the weeds which can be controlled by the present compound or the present method include the following weeds, but are not limited thereto.
Urticaceae weeds: small nettle (Urtica urens) Polygonaceae weeds: black bindweed (Polygonum convolvulus), pale persicaria (Polygonum lapathifolium), Pennsylvania smartweed (Polygonum pensylvanicum), redshank (Polygonum persicaria), bristly lady's-thumb (Polygonum longisetum), knotgrass (Polygonum aviculare), equal-leaved knotgrass (Polygonum arenastrum), Japanese knotweed (Polygonum cuspidatum), Japanese dock (Rumex japonicus), curly dock (Rumex crispus), blunt-leaved dock (Rumex obtusifolius), common sorrel (Rumex acetosa)
Portulacaceae weeds: common purslane (Portulaca oleracea)
Caryophyllaceae weeds: common chickweed (Stellaria media), water chickweed (Stellaria aquatica), common mouse-ear (Cerastium holosteoides), sticky mouse-ear (Cerastium glomeratum), corn spurrey (Spergula arvensis), five-wound catchfly (Silene gallica)
Molluginaceae weeds: carpetweed (Mollugo verticillata)
Chenopodiaceae weeds: common lambsquarters (Chenopodium album), Indian goosefoot (Chenopodium ambrosioides), Kochia (Kochia scoparia), spiny saltwort (Salsola kali), Orach (Atriplex spp.)
Amaranthaceae weeds: redroot pigweed (Amaranthus retroflexus), slender amaranth (Amaranthus viridis), livid amaranth (Amaranthus lividus), spiny amaranth (Amaranthus spinosus), smooth pigweed (Amaranthus hybridus), Palmer amaranth (Amaranthus palmeri), green pigweed (Amaranthus patulus), waterhemp (Amaranthus tuberculatus=Amaranthus rudis=Amaranthus tamariscinus), prostrate pigweed (Amaranthus blitoides), large-fruit amaranth (Amaranthus deflexus), mucronate amaranth (Amaranthus quitensis), alligator weed (Alternanthera philoxeroides), sessile alligator weed (Alternanthera sessilis), perrotleaf (Alternanthera tenella)
Papaveraceae weeds: common poppy (Papaver rhoeas), field poppy (Papaver dubium), Mexican prickle poppy (Argemone mexicana)
Brassicaceae weeds: wild radish (Raphanus raphanistrum), radish (Raphanus sativus), wild mustard (Sinapis arvensis), shepherd's purse (Capsella bursa-pastoris), white mustard (Brassica juncea), oilseed rape (Brassica napus), pinnate tansy mustard (Descurainia pinnata), marsh yellowcress (Rorippa islandica), yellow fieldcress (Rorippa sylvestris), field pennycress (Thlaspi arvense), turnip weed (Myagrum rugosum), Virginia pepperweed (Lepidium virginicum), slender wartcress (Coronopus didymus)
Capparaceae weeds: African cabbage (Cleome affinis)
Fabaceae weeds: Indian joint vetch (Aeschynomene indica), zigzag joint vetch (Aeschynomene rudis), hemp sesbania (Sesbania exaltata), sickle pod (Cassia obtusifolia), coffee senna (Cassia occidentalis), Florida beggar weed (Desmodium tortuosum), wild groundnut (Desmodium adscendens), Illinois tick trefoil (Desmodium illinoense), white clover (Trifolium repens), kudzu (Pueraria lobata), narrowleaf vetch (Vicia angustifolia), hairy indigo (Indigofera hirsuta), Indigofera truxillensis, common cowpea (Vigna sinensis)
Oxalidaceae weeds: creeping wood sorrel (Oxalis corniculata), European wood sorrel (Oxalis stricta), purple shamrock (Oxalis oxyptera)
Geraniaceae weeds: Carolina geranium (Geranium carolinense), common storksbill (Erodium cicutarium)
Euphorbiaceae weeds: sun spurge (Euphorbia helioscopia), annual spurge (Euphorbia maculata), prostrate spurge (Euphorbia humistrata), Hungarian spurge (Euphorbia esula), wild poinsettia (Euphorbia heterophylla), hyssop-leaf sandmat (Euphorbia brasiliensis), Asian copperleaf (Acalypha australis), tropic croton (Croton glandulosus), lobed croton (Croton lobatus), long-stalked phyllanthus (Phyllanthus corcovadensis), castor bean (Ricinus communis)
Malvaceae weeds: velvetleaf (Abutilon theophrasti), arrow-leaf sida (Sida rhombifolia), heart-leaf sida (Sida cordifolia), prickly sida (Sida spinosa), Sida glaziovii, Sida santaremnensis, bladder weed (Hibiscus trionum), spurred anoda (Anoda cristata), spine-seeded false-mallow (Malvastrum coromandelianum)
Onagraceae weeds: Ludwigia epilobioides, long-fruited primrose willow (Ludwigia octovalvis), winged water primrose (Ludwigia decurrens), common evening-primrose (Oenothera biennis), cutleaf evening-primrose (Oenothera laciniata)
Sterculiaceae weeds: Florida waltheria (Waltheria indica)
Violaceae weeds: field violet; Viola arvensis, wild violet; Viola tricolor
Cucurbitaceae weeds: bur cucumber (Sicyos angulatus), wild cucumber (Echinocystis lobata), bitter balsam apple (Momordica charantia)
Lythraceae weeds: Ammannia multiflora, eared redstem (Ammannia auriculata), scarlet toothcup (Ammannia coccinea), purple loosestrife (Lythrum salicaria), Indian toothcup (Rotala indica)
Elatinaceae weeds: three-stamen waterwort (Elatine triandra), California waterwort (Elatine californica)
Apiaceae weeds: Chinese celery (Oenanthe javanica), wild carrot (Daucus carota), carrot fern (Conium maculatum)
Araliaceae weeds: lawn pennywort (Hydrocotyle sibthorpioides), floating pennywort (Hydrocotyle ranunculoides)
Ceratophyllaceae weeds: common hornwort (Ceratophyllum demersum)
Cabombaceae weeds: Carolina fanwort (Cabomba caroliniana)
Haloragaceae weeds: Brazilian water milfoil (Myriophyllum aquaticum), whorled water milfoil (Myriophyllum verticillatum), water milfoils (Myriophyllum spicatum, Myriophyllum heterophyllum, etc.)
Sapindaceae weeds: heartseed (Cardiospermum halicacabum)
Primulaceae weeds: scarlet pimpernel (Anagallis arvensis)
Asclepiadaceae weeds: common milkweed (Asclepias syriaca), honeyvine milkweed (Ampelamus albidus)
Rubiaceae weeds: catchweed bedstraw (Galium aparine), Galium spurium var. echinospermon, broadleaf buttonweed (Spermacoce latifolia), Brazil calla lily (Richardia brasiliensis), broadleaf buttonweed (Borreria alata)
Convolvulaceae weeds: Japanese morning glory (Ipomoea nil), ivy-leaf morning glory (Ipomoea hederacea), tall morning glory (Ipomoea purpurea), entire-leaf morning glory (Ipomoea hederacea var. integriuscula), pitted morning glory (Ipomoea lacunosa), three-lobe morning glory (Ipomoea triloba), blue morning glory (Ipomoea acuminata), scarlet morning glory (Ipomoea hederifolia), red morning glory (Ipomoea coccinea), cypress-vine morning glory (Ipomoea quamoclit), Ipomoea grandifolia, Ipomoea aristolochiaefolia, Cairo morning glory (Ipomoea cairica), field bindweed (Convolvulus arvensis), Japanese false bindweed (Calystegia hederacea), Japanese bindweed (Calystegia japonica), ivy woodrose (Merremia hederacea), hairy woodrose (Merremia aegyptia), roadside woodrose (Merremia cissoides), small-flower morning glory (Jacquemontia tamnifolia)
Boraginaceae weeds: field forget-me-not (Myosotis arvensis)
Lamiaceae weeds: purple deadnettle (Lamium purpureum), common henbit (Lamium amplexicaule), lion's ear (Leonotis nepetaefolia), wild spikenard (Hyptis suaveolens), Hyptis lophanta, Siberian motherwort (Leonurus sibiricus), field-nettle betony (Stachys arvensis)
Solanaceae weeds: jimsonweed (Datura stramonium), black nightshade (Solanum nigrum), American black nightshade (Solanum americanum), eastern black nightshade (Solanum ptycanthum), hairy nightshade (Solanum sarrachoides), buffalo bur (Solanum rostratum), soda-apple nightshade (Solanum aculeatissimum), sticky nightshade (Solanum sisymbriifolium), horse nettle (Solanum carolinense), cutleaf groundcherry (Physalis angulata), smooth groundcherry (Physalis subglabrata), apple of Peru (Nicandra physalodes)
Scrophulariaceae weeds: ivyleaf speedwell (Veronica hederaefolia), common speedwell (Veronica persica), corn speedwell (Veronica arvensis), common false pimpernel (Lindernia procumbens), false pimpernel (Lindernia dubia), Lindernia angustifolia, round-leaf water hyssop (Bacopa rotundifolia), Dopatrium (Dopatrium junceum), Gratiola japonica,
Plantaginaceae weeds: Asiatic plantain (Plantago asiatica), narrow-leaved plantain (Plantago lanceolata), broadleaf plantain (Plantago major), marsh water starwort (Callitriche palustris)
Asteraceae weeds: common cocklebur (Xanthium pensylvanicum), large cocklebur (Xanthium occidentale), Canada cocklebur (Xanthium italicum), common sunflower (Helianthus annuus), wild chamomile (Matricaria chamomilla), scentless chamomile (Matricaria perforata), corn marigold (Chrysanthemum segetum), rayless mayweed (Matricaria matricarioides), Japanese mugwort (Artemisia princeps), common mugwort (Artemisia vulgaris), Chinese mugwort (Artemisia verlotorum), tall goldenrod (Solidago altissima), common dandelion (Taraxacum officinale), hairy galinsoga (Galinsoga ciliata), small-flower galinsoga (Galinsoga parviflora), common groundsel (Senecio vulgaris), flower-of-souls (Senecio brasiliensis), Senecio grisebachii, fleabane (Conyza bonariensis), Guernsey fleabane (Conyza sumatrensis), marestail (Conyza canadensis), common ragweed (Ambrosia artemisiifolia), giant ragweed (Ambrosia trifida), three-cleft bur-marigold (Bidens tripartita), hairy beggarticks (Bidens pilosa), common beggarticks (Bidens frondosa), greater beggarticks (Bidens subalternans), Canada thistle (Cirsium arvense), black thistle (Cirsium vulgare), blessed milkthistle (Silybum marianum), musk thistle (Carduus nutans), prickly lettuce (Lactuca serriola), annual sowthistle (Sonchus oleraceus), spiny sowthistle (Sonchus asper), beach creeping oxeye (Wedelia glauca), perfoliate blackfoot (Melampodium perfoliatum), red tasselflower (Emilia sonchifolia), wild marigold (Tagetes minuta), para cress (Blainvillea latifolia), coat buttons (Tridax procumbens), Bolivian coriander (Porophyllum ruderale), Paraguay starbur (Acanthospermum australe), bristly starbur (Acanthospermum hispidum), balloon vine (Cardiospermum halicacabum), tropic ageratum (Ageratum conyzoides), common boneset (Eupatorium perfoliatum), fireweed (Erechtites hieracifolia), American cudweed (Gamochaeta spicata), linear-leaf cudweed (Gnaphalium spicatum), Jaegeria hirta, ragweed parthenium (Parthenium hysterophorus), small yellow crownbeard (Siegesbeckia orientalis), lawn burweed (Soliva sessilis), white eclipta (Eclipta prostrata), American false daisy (Eclipta alba), spreading sneezeweed (Centipeda minima)
Alismataceae weeds: dwarf arrowhead (Sagittaria pygmaea), threeleaf arrowhead (Sagittaria trifolia), arrowhead (Sagittaria sagittifolia), giant arrowhead (Sagittaria montevidensis), Sagittaria aginashi, channelled water plantain (Alisma canaliculatum), common water plantain (Alisma plantago-aquatica)
Limnocharitaceae weeds: Sawah flowering rush (Limnocharis flava)
Hydrocharitaceae weeds: American frogbit (Limnobium spongia), Florida elodea (Hydrilla verticillata), common water nymph (Najas guadalupensis)
Araceae weeds: Nile cabbage (Pistia stratiotes)
Lemnaceae weeds: three-nerved duckweed (Lemna aoukikusa, Lemna paucicostata, Lemna aequinoctialis), common duckmeat (Spirodela polyrhiza), Wolffia spp.
Potamogetonaceae weeds: roundleaf pondweed (Potamogeton distinctus), pondweeds (Potamogeton crispus, Potamogeton illinoensis, Stuckenia pectinata, etc.)
Liliaceae weeds: wild onion (Allium canadense), wild garlic (Allium vineale), Chinese garlic (Allium macrostemon)
Pontederiaceae weeds: common water hyacinth (Eichhornia crassipes), blue mud plantain (Heteranthera limosa), Monochoria korsakowii, heartshape false pickerelweed (Monochoria vaginalis)
Commelinaceae weeds: common dayflower (Commelina communis), tropical spiderwort (Commelina benghalensis), erect dayflower (Commelina erecta), Asian spiderwort (Murdannia keisak)
Poaceae weeds: common barnyardgrass (Echinochloa crus-galli), early barnyardgrass (Echinochloa oryzicola), barnyard grass (Echinochloa crus-galli var formosensis), late watergrass (Echinochloa oryzoides), jungle rice (Echinochloa colonum), Gulf cockspur (Echinochloa crus-pavonis), green foxtail (Setaria viridis), giant foxtail (Setaria faberi), yellow foxtail (Setaria glauca), knotroot foxtail (Setaria geniculata), southern crabgrass (Digitaria ciliaris), large crabgrass (Digitaria sanguinalis), Jamaican crabgrass (Digitaria horizontalis), sourgrass (Digitaria insularis), goosegrass (Eleusine indica), annual bluegrass (Poa annua), rough-stalked meadowgrass (Poa trivialis), Kentucky bluegrass (Poa pratensis), short-awn foxtail (Alopecurus aequalis), blackgrass (Alopecurus myosuroides), wild oat (Avena fatua), Johnsongrass (Sorghum halepense), shataken (grain sorghum; Sorghum vulgare), quackgrass (Agropyron repens), Italian ryegrass (Lolium multiflorum), perennial ryegrass (Lolium perenne), bomugi (rigid ryegrass; Lolium rigidum), rescue brome (Bromus catharticus), downy brome (Bromus tectorum), Japanese brome grass (Bromus japonicus), cheat (Bromus secalinus), cheatgrass (Bromus tectorum), foxtail barley (Hordeum jubatum), jointed goatgrass (Aegilops cylindrica), reed canarygrass (Phalaris arundinacea), little-seed canary grass (Phalaris minor), silky bentgrass (Apera spica-venti), fall panicum (Panicum dichotomiflorum), Texas panicum (Panicum texanum), guineagrass (Panicum maximum), broadleaf signalgrass (Brachiaria platyphylla), Congo signal grass (Brachiaria ruziziensis), Alexander grass (Brachiaria plantaginea), Surinam grass (Brachiaria decumbens), palisade grass (Brachiaria brizantha), creeping signalgrass (Brachiaria humidicola), southern sandbur (Cenchrus echinatus), field sandbur (Cenchrus pauciflorus), woolly cupgrass (Eriochloa villosa), feathery pennisetum (Pennisetum setosum), Rhodes grass (Chloris gayana), feathertop Rhodes grass (Chloris virgata), India lovegrass (Eragrostis pilosa), Natal grass (Rhynchelytrum repens), crowfoot grass (Dactyloctenium aegyptium), winkle grass (Ischaemum rugosum), swamp millet (Isachne globosa), common rice (Oryza sativa), bahiagrass (Paspalum notatum), coastal sand paspalum (Paspalum maritimum), mercergrass (Paspalum distichum), kikuyugrass (Pennisetum clandestinum), West Indies pennisetum (Pennisetum setosum), itch grass (Rottboellia cochinchinensis), Asian sprangletop (Leptochloa chinensis), salt-meadow grass (Leptochloa fascicularis), Christmas-tree grass (Leptochloa filiformis), Amazon sprangletop (Leptochloa panicoides), Japanese cutgrass (Leersia japonica), Leersia sayanuka, cutgrass (Leersia oryzoides), Glyceria leptorrhiza, sharpscale mannagrass (Glyceria acutiflora), great watergrass (Glyceria maxima), redtop (Agrostis gigantea), carpet bent (Agrostis stolonifera), Bermuda grass (Cynodon dactylon), cocksfoot (Dactylis glomerata), centipede grass (Eremochloa ophiuroides), tall fescue (Festuca arundinacea), red fescue (Festuca rubra), lalang (Imperata cylindrica), Chinese fairy grass (Miscanthus sinensis), switchgrass (Panicum virgatum), Japanese lawngrass (Zoysia japonica)
Cyperaceae weeds: Asian flatsedge (Cyperus microiria), rice flatsedge (Cyperus iria), hedgehog cyperus (Cyperus compressus), small-flowered nutsedge (Cyperus difformis), lax-flat sedge (Cyperus flaccidus), Cyperus globosus, Cyperus nipponicus, fragrant flatsedge (Cyperus odoratus), mountain nutsedge (Cyperus serotinus), purple nutsedge (Cyperus rotundus), yellow nutsedge (Cyperus esculentus), pasture spike sedge (Kyllinga gracillima), green Kyllinga (Kyllinga brevifolia), grasslike fimbristylis (Fimbristylis miliacea), annual fringerush (Fimbristylis dichotoma), slender spikerush (Eleocharis acicularis), Eleocharis kuroguwai, Japanese bulrush (Schoenoplectiella hotarui), hardstem bulrush (Schoenoplectiella juncoides), Schoenoplectiella wallichii, rough-seed bulrush (Schoenoplectiella mucronatus), Schoenoplectiella triangulatus, Schoenoplectiella nipponicus, triangular club-rush (Schoenoplectiella triqueter), Bolboschoenus koshevnikovii, river bulrush (Bolboschoenus fluviatilis)
Equisetaceae weeds: field horsetail (Equisetum arvense), marsh horsetail (Equisetum palustre)
Salviniaceae weeds: floating fern (Salvinia natans)
Azollaceae weeds: Japanese mosquitofern (Azolla japonica), feathered mosquito fern (Azolla pinnata)
Marsileaceae weeds: clover fern (Marsilea quadrifolia)
Other: Filamentous algae (Pithophora, Cladophora), Bryophyta, Marchantiophyta, Anthocerotophyta, Cyanobacteria, Pteridophyta, sucker of perennial crop (pome fruits, stone fruits, berry fruits, nuts, citrus fruits, hops, grapes, etc.)

In the above weeds, mutations within the species are not particularly limited. Namely, the weeds also include any weeds that have reduced sensitivity (also referred to “have resistance”) to a specific herbicide. The reduced sensitivity may be attributed to a mutation at a target site (target site mutation), or may be attributed to any factors other than target site mutation (non-target site mutation). Target site mutation include those in which the substitution of amino acid residue of a protein as a target site occurred due to mutation of an open reading frame corresponding to amino acid sequence of the protein, and those in which the protein as the target site is overexpressed due to mutation such as deletion of the suppressor sequence in the promoter region, amplification of the enhancer sequence, or increase in the number of copies of gene.

Examples of the factor reducing sensitivity due to non-target site mutation include metabolic enhancement, defective absorption, defective transition, efflux out of the system and the like. Examples of the factor of the metabolic enhancement includes enhanced activity of metabolic enzymes such as cytochrome P450 monooxygenases, aryl acylamidases, esterases and glutathione S-transferase. The efflux out of the system includes the transportation to a vacuole by an ABC transporter.

Examples of herbicide-resistant weeds include followings.

### Resistance to Glyphosate:

Examples of the reduced sensitivity of weeds due to target site mutation include weeds in which the substitution of any one amino acid residue or multiple amino acid residues selected from the below-mentioned amino acid residues occurs in EPSPS gene. Thr102Ile, Pro106Ser, Pro106Ala, Pro106Leu and Pro106Thr. Particularly, those with both of Thr102Ile and Pro106Ser, and those with both of Thr102Ile and Pro106Thr are mentioned. Glyphosate-resistant Indian goosegrass (Eleusine indica), Italian ryegrass (Lolium multiflorum), rigid ryegrass (Lolium rigidum), perennial ryegrass (Lolium perenne), Bidens subalternans and the like each having the target-site mutation can be controlled effectively. Similarly, examples of the resistance to glyphosate due to target site mutation include those in which the number of copies of EPSPS gene is increased (PNAS, 2018 115 (13) 3332-3337). According to the present invention, Glyphosate-resistant palmer amaranth (Amaranthus palmeri), waterhemp (Amaranthus tuberculatus), Kochia (Kochia scoparia) and the like in which the number of copies of EPSPS gene is increased can be controlled effectively. Examples of the reduced sensitivity of weeds due to non-target site mutation include Glyphosate-resistant Canadian horseweed (Conyza canadensis), Sumatran fleabane (Conyza sumatrensis), flax-leaf fleabane (Conyza bonariensis) and the like in which an ABC transporter is involved can be controlled effectively according to the present invention. Furthermore, jungle rice (Echinochloa colona) in which sensitivity to glyphosate is reduced by increasing expression of aldo-keto reductase known as non-target site mutation (Plant Physiology 181, 1519-1534) is effectively controlled by the present invention.

### Resistance to ALS-Inhibition-Type Herbicides:

Examples of the reduced sensitivity of weeds due to target site mutation include weeds each having a mutation capable of causing the substitution of one amino acid residue or multiple amino acid residues selected from the below-mentioned amino acid residues in ALS gene as a target site mutation. Ala122Thr, Ala122Val, Ala122Tyr, Pro197Ser, Pro197His, Pro197Thr, Pro197Arg, Pro197Leu, Pro197Gln, Pro197Ala, Pro197Ile, Ala205Val, Ala205Phe, Asp376Glu, Asp376Gln, Asp376Asn, Arg377His, Trp574Leu, Trp574Gly, Trp574Met, Ser653Thr, Ser653Asn, Ser635Ile, Gly654Glu and Gly645Asp. According to the present invention, ALS inhibitor-resistant redroot amaranth (Amaranthus retroflexus), smooth pigweed (Amaranthus hybridus), palmer amaranth (Amaranthus palmeri), waterhemp (Amaranthus tuberculatus), Kochia (Kochia scoparia) and the like each having the target site mutation can be controlled effectively. Examples of the reduced sensitivity of weeds due to non-target site mutation include weeds each having such a non-target site mutation that CYP or GST is involved to make the weed resistant to an ALS inhibitor, and these weeds can also be controlled effectively according to the present invention. There have been known, as examples of the weeds, rigid ryegrass (Lolium rigidum) in which CYP81A10 and CYP81A1v1 are overexpressed, rice barnyardgrass (Echinochloa oryzoides) in which CYP81A12 and CYP81A21 are overexpressed, and blackgrass (Alopecurus myosuroides Huds) in which GSTF1 and GSTU2 are overexpressed.

### Resistance to ACCase Inhibitors:

Examples of the reduced sensitivity of weeds due to target site mutation include weeds each having a mutation capable of causing the substitution of one amino acid residue or multiple amino acid residues in ACCase gene. Ile1781Leu, Ile1781Val, Ile1781Thr, Trp1999Cys, Trp1999Leu, Ala2004Val, Trp2027Cys, Ile2041Asn, Ile2041Val, Asp2078Gly, Asp2078Glu, Cys2088Arg, Gly2096Ala, Gly2096Ser. According to the present invention, ACCase-resistant weeds having these target site mutations are effectively controlled. Examples of the reduced sensitivity of weeds due to non-target site mutation include weeds each of which becomes resistant to an ACCase inhibitor as the result of the involvement of CYP or GST. There have been known, as examples of the weeds, rigid ryegrass (Lolium rigidum) in which CYP81A10 and CYP81A1v1 are overexpressed, rice barnyardgrass (Echinochloa oryzoides) in which CYP81A12 and CYP81A21 are overexpressed, and blackgrass (Alopecurus myosuroides Huds) in which GSTF1 and GSTU2 are overexpressed.

### Resistance to PPO Inhibitors:

Examples of the reduced sensitivity of weeds due to target site mutation include weeds each having a mutation capable of causing the substitution of one amino acid residue or multiple amino acid residues in PPO gene. These mutations are known as or predicted to become carfentrazone-ethyl-, fomesafen- and lactofen-resistance mutations. Arg128Leu, Arg128Met, Arg128Gly, Arg128His, Arg128Ala, Arg128Cys, Arg128Glu, Arg128Ile, Arg128Lys, Arg128Asn, Arg128Gln, Arg128Ser, Arg128Thr, Arg128Val, Arg128Tyr, Gly210 deficit, Ala210 deficit, Gly210Thr, Ala210Thr, Gly211 deficit, Gly114Glu, Ser149Ile, Gly399Ala (all of amino acid numbers are standardized by sequence of PPO2 of palmer amaranth (Amaranthus palmeri)). Usually, PPO genes in a weed includes PPO1 gene and PPO2 gene. The above-mentioned mutation may occur in either one or both of PPO1 gene and PPO2 gene. It is preferred that the mutation occurs in PPO2 gene. For example, Arg128Met means that a mutation occurs in an amino acid residue located at position-128. In PPO2 gene of common ragweed (Ambrosia artemisiaefolia), the mutation corresponds to position-98 (Weed Science 60, 335-344) and is known as Arg98Leu, and this Arg98 is the same as Arg128 in the present specification. In PPO gene of weeds to be controlled by the present invention, Arg128Met and Arg128Gly are known in palmer amaranth (Amaranthus palmeri) (Pest Management Science 73, 1559-1563), Arg128Gly is known as PP02 of waterhemp (Amaranthus tuberculatus) (Pest Management Science, 2019; 75:3235-3244), Arg128Ile and Arg128Lys are known as PP02 of waterhemp (Amaranthus tuberculatus) (Pest Management Science, 2019; 75:3235-3244), Arg128His is known as Arg132His by PPO2 of rigid ryegrass (Lolium rigidum) (WSSA annual meeting, 2018), Gly114Glu, Ser149Ile, and Gly399Ala are known by PPO2 of palmer amaranth (Amaranthus palmeri) (Frontiers in Plant Science 10, Article 568), and Ala210Thr is known as Ala212Thr by PPO1 of Indian goosegrass (Eleusine indica) (Pest Management Science, doi: 10.1002/ps.5703). According to the present invention, PPO inhibitor-resistant weeds each having one of the above-mentioned target site mutations can be controlled effectively. However, the PPO inhibitor-resistant weed to be controlled is not limited to these weeds. Namely, not only palmer amaranth (Amaranthus palmeri) having a mutation of Arg128Leu, Arg128Met, Arg128Gly, Arg128His, Arg128Ala, Arg128Cys, Arg128Glu, Arg128Ile, Arg128Lys, Arg128Asn, Arg128Gln, Arg128Ser, Arg128Thr, Arg128Val, Arg128Tyr, Gly210 deficit, Ala210 deficit, Gly210Thr, Ala210Thr, Gly211 deficit, Gly114Glu, Ser149Ile or Gly399Ala in PPO1 or PPO2 but also, for example, waterhemp (Amaranthus tuberculatus) having the same mutation, common ragweed (Ambrosia artemisiaefolia) having the same mutation and wild poinsettia (Euphorbia cyathophora) having the same mutation can be controlled effectively. As an example of the reduced sensitivity of weeds due to non-target site mutation, waterhemp (Amaranthus tuberculatus) which becomes resistant to carfentrazone-ethyl is known as waterhemp (Amaranthus tuberculatus) and palmer amaranth (Amaranthus palmeri) which become resistant to a PPO inhibitor as the result of the involvement of CYP or GST (PLOS ONE, doi: 10.1371/journal.pone.0215431), and these weeds are effectively controlled according to the present invention.

### Resistance to Auxin-Type Herbicides:

Examples of the target site mutation include a mutation which causes Gly-Asn in a degron region in AUX/IAA gene. According to the present invention, Kochia (Kochia scoparia), palmer amaranth (Amaranthus palmeri) and waterhemp (Amaranthus tuberculatus) each having this mutation can be controlled effectively. As the non-target site mutation, dicamba-resistant green amaranth (Amaranthus chlorostachys Wiil) and 2,4-D-resistant waterhemp (Amaranthus tuberculatus) to which the involvement of CYP is suggested are known. These weeds can be controlled effectively according to the present invention. These weeds can also be controlled in the case of the non-target site mutation in which GST is involved.

### Resistance to HPPD Inhibitors:

Examples of the reduced sensitivity of weeds due to non-target site mutation include waterhemp (Amaranthus tuberculatus), palmer amaranth (Amaranthus palmeri) and the like each of which becomes resistant to an HPPD inhibitor as the result of the involvement of CYP or GST, which are effectively controlled according to the present invention. As examples thereof, palmer amaranth (Amaranthus palmeri) in which CYP72A219, CYP81B and CYP81E8 are overexpressed are known.

### Resistance to Photosystem II Inhibitors:

Examples of the reduced sensitivity of weeds due to target site mutation include weeds each having a mutation capable of causing the substitution of one amino acid residue or multiple amino acid residues selected from the below-mentioned amino acid residues in psbA gene. Val219Ile, Ser264Gly, Ser264Ala, Phe274Val. According to the present invention, photosystem II inhibitor-resistant palmer amaranth (Amaranthus palmeri) and waterhemp (Amaranthus tuberculatus) each having this target site mutation can be controlled effectively. Examples of the reduced sensitivity of weeds due to non-target site mutation include palmer amaranth (Amaranthus palmeri), waterhemp (Amaranthus tuberculatus) and the like each of which becomes resistant to a photosystem II inhibitor as the result of the involvement of CYP, GST or AAA. These weeds can be effectively controlled according to the present invention. As an example thereof, rigid ryegrass (Lolium rigidum) in which CYP71R4 are overexpressed is known.

### Resistance to Glutamate Synthase Inhibitors:

Examples of the reduced sensitivity of weeds due to target site mutation include weeds each having a mutation capable of causing the amino acid substitution of Asp171Asn in a glutamate synthase gene. According to the present invention, glutamate synthase inhibitor-resistant palmer amaranth (Amaranthus palmeri), waterhemp (Amaranthus tuberculatus) and the like each having this target site mutation can be controlled effectively. Examples of the reduced sensitivity of weeds due to non-target site mutation include palmer amaranth (Amaranthus palmeri), waterhemp (Amaranthus tuberculatus) and the like each of which becomes resistant to glufosinate as the result of the involvement of CYP or GST. These weeds can be effectively controlled according to the present invention. As an example thereof, palmer amaranth (Amaranthus palmeri) in which CYP72A219, CYP81B and CYP81E8 are overexpressed is known.

Resistant weeds each having a “combination (stack)” of at least two groups selected from the above-mentioned groups (arbitrarily selected two groups, arbitrarily selected three groups, arbitrarily selected four groups, arbitrarily selected five groups, arbitrarily selected six groups, arbitrarily selected seven groups or arbitrarily selected eight groups) can also be controlled effectively. For example, waterhemp (Amaranthus tuberculatus) having resistance to all of a photosystem II inhibitor, a HPPD inhibitor, 2,4-D, a PPO inhibitor, an ALS inhibitor and glyphosate is known. This weed can also be effectively controlled. The stack may be a combination of target site mutations or a combination of non-target site mutations, or a combination of a target site mutation and a non-target site mutation.

In the cultivation of a crop in the present invention, a plant-nutritional management in a common crop cultivation can be made. A fertilization system may be one based on Precision Agriculture, or may be a conventional homogeneous one. Alternatively, a nitrogen-fixing bacterium or a mycorrhizal fungus may be inoculated together with a seed application.

### EXAMPLES

Hereinbelow, the present invention will be described in more detail by way of Examples. However, the present invention is not limited to these Examples.

### Reference Production Example 1

A mixture of 0.30 g of 1-{2-chloro-4-fluoro-5-[3-methyl-2,6-dioxo-4-(trifluoromethyl)-1,2,3,6-tetrahydropyrimidin-1-yl]phenoxy}cyclopropanecarboxylic acid, 0.15 g of methyl 2-bromopropionate, 0.08 g of sodium hydrogen carbonate, and 3 mL of DMF was stirred at 50° C. for 5 hours. To the resulting mixture, water and an aqueous saturated sodium hydrogen carbonate solution were added, followed by extraction with methyl tert-butyl ether (hereinafter referred to as MTBE). The resulting organic layer was sequentially washed with water and saturated saline, dried over anhydrous magnesium sulfate and then concentrated under reduced pressure. The resulting residue was purified by silica gel column chromatography (hexane:MTBE=1:1) to obtain 0.31 g of a compound (I-15) represented by the following formula.

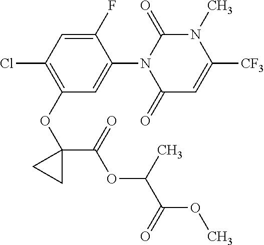 [SMILES: COC(=O)C(C)OC(=O)C1(Oc2cc(-n3c(=O)cc(C(F)(F)F)n(C)c3=O)c(F)cc2Cl)CC1]

Compound (I-15): ¹H-NMR (CDCl₃) δ: 7.29 (0.5H, d), 7.27 (0.5H, d), 7.20 (0.5H, d), 7.12 (0.5H, d), 6.34 (0.5H, s), 6.32 (0.5H, s), 5.10 (0.5H, q), 5.09 (0.5H, q), 3.69 (1.5H, s), 3.68 (1.5H, s), 3.55 (1.5H, d), 3.53 (1.5H, d), 1.75-1.60 (2H, m), 1.51-1.37 (2H, m), 1.43 (3H, d)

### Reference Production Example 2

A mixture of 0.31 g of 1-{2-chloro-4-fluoro-5-[3-methyl-2,6-dioxo-4-(trifluoromethyl)-1,2,3,6-tetrahydropyrimidin-1-yl]phenoxy}cyclopropanecarboxylic acid chloride, 0.10 g of ethyl lactate, 0.11 g of triethylamine, and 3 mL of chloroform was stirred at room temperature for 12 hours. To the resulting mixture, water was added, followed by extraction with MTBE. The resulting organic layer was sequentially washed with water and saturated saline, dried over anhydrous magnesium sulfate and then concentrated under reduced pressure. The resulting residue was purified by silica gel column chromatography (hexane: MTBE=1:1) to obtain 0.26 g of a compound (I-29) represented by the following formula.

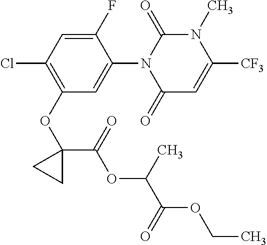 [SMILES: CCOC(=O)C(C)OC(=O)C1(Oc2cc(-n3c(=O)cc(C(F)(F)F)n(C)c3=O)c(F)cc2Cl)CC1]

Compound (I-29): ¹H-NMR (CDCl₃) δ: 7.29 (0.5H, d), 7.27 (0.5H, d), 7.22 (0.5H, d), 7.14 (0.5H, d), 6.34 (0.5H, s), 6.31 (0.5H, s), 5.07 (0.5H, q), 5.06 (0.5H, q), 4.14 (1H, dq), 4.13 (1H, dq), 3.55 (1.5H, d), 3.53 (1.5H, d), 1.76-1.59 (2H, m), 1.51-1.36 (2H, m), 1.43 (3H, d), 1.24 (3H, t)

### Reference Production Example 3

A mixture of 20 mg of tert-butyl 2-{{1-{2-chloro-4-fluoro-5-[3-methyl-2,6-dioxo-4-(trifluoromethyl)-1,2,3,6-tetrahydropyrimidin-1-yl]phenoxy}cyclopropanecarbonyl}oxy}propionate produced according to the method mentioned in Reference Production Example 1, 0.5 mL of trifluoroacetic acid, and 0.5 mL of chloroform was stirred at room temperature for 5 hours. To the resulting mixture, 2 mL of toluene was added, followed by concentration under reduced pressure to obtain 16 mg of a compound (I-1) represented by the following formula.

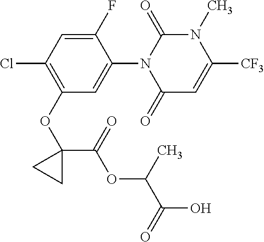 [SMILES: CC(OC(=O)C1(Oc2cc(-n3c(=O)cc(C(F)(F)F)n(C)c3=O)c(F)cc2Cl)CC1)C(=O)O]

Compound (I-1): ¹H-NMR (CDCl₃) δ: 7.32 (0.5H, d), 7.29 (0.5H, d), 7.07 (0.5H, d), 7.04 (0.5H, d), 6.34 (0.5H, s), 6.31 (0.5H, s), 5.18 (0.5H, q), 5.17 (0.5H, q), 3.56 (1.5H, d), 3.55 (1.5H, d), 1.75-1.60 (2H, m), 1.58-1.50 (1H, m), 1.48 (3H, d), 1.45-1.37 (1H, m)

### Reference Production Example 4

The following compounds produced according to the methods mentioned in Reference Production Example 1, Reference Production Example 2, or Reference Production Example 3, and physical property values thereof are shown below.

Compounds in which R¹, R², and R³ are any of combinations shown in Table 2 in the compound represented by formula (I).

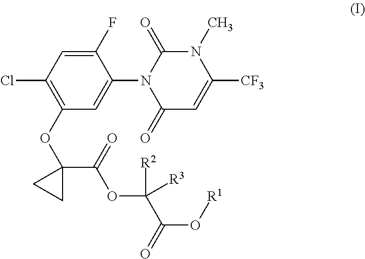

TABLE 2

| Compound | R¹ | R² | R³ |
|---|---|---|---|
| (I-30) | Et | Me | Me |
| (I-33) | Et | Et | H |

| | | |
|---|---|---|
| (I-41) | Et | —(CH₂)₂— |

In Table 2, Me represents methyl group, and Et represents an ethyl group. —(CH₂)₂— represents that R² and R³ are bonded to each other to form —(CH₂)₂—.

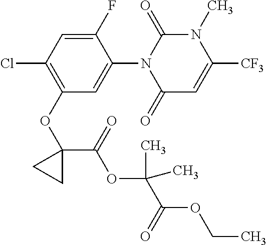 [SMILES: CCOC(=O)C(C)(C)OC(=O)C1(Oc2cc(-n3c(=O)cc(C(F)(F)F)n(C)c3=O)c(F)cc2Cl)CC1]

Compound (I-30): ¹H-NMR (CDCl₃) δ: 7.29 (1H, d), 7.12 (1H, d), 6.34 (1H, s), 4.12 (2H, q), 3.54 (3H, d), 1.63-1.60 (2H, m), 1.51 (3H, s), 1.49 (3H, s), 1.45-1.35 (2H, m), 1.22 (3H, t)

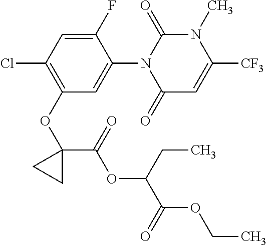 [SMILES: CCOC(=O)C(CC)OC(=O)C1(Oc2cc(-n3c(=O)cc(C(F)(F)F)n(C)c3=O)c(F)cc2Cl)CC1]

Compound (I-33): ¹H-NMR (CDCl₃) δ: 7.29 (0.5H, d), 7.27 (0.5H, d), 7.22 (0.5H, d), 7.15 (0.5H, d), 6.33 (0.5H, s), 6.31 (0.5H, s), 4.93 (0.5H, t), 4.92 (0.5H, t), 4.14 (1H, dq), 4.13 (1H, dq), 3.55 (1.5H, d), 3.52 (1.5H, d), 1.77-1.59 (2H, m), 1.50-1.35 (2H, m), 1.34-1.19 (2H, m), 1.24 (3H, t), 0.82 (1.5H, t), 0.81 (1.5H, t)

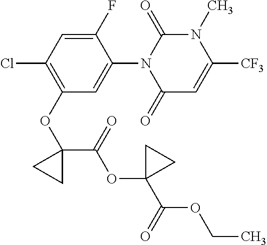 [SMILES: CCOC(=O)C1(OC(=O)C2(Oc3cc(-n4c(=O)cc(C(F)(F)F)n(C)c4=O)c(F)cc3Cl)CC2)CC1]

Compound (I-41): ¹H-NMR (CDCl₃) δ: 7.28 (1H, d), 7.14 (1H, d), 6.33 (1H, s), 4.10 (2H, q), 3.55 (3H, d), 1.69-1.64 (2H, m), 1.51-1.41 (4H, m), 1.30-1.24 (2H, m), 1.20 (3H, t)

Criteria for the evaluation of the herbicidal effect and the harmful effect on crops shown in the below-mentioned Examples will be described.

### [Herbicidal Effect and Harmful Effect on Crops]

The herbicidal effect was rated within a range of 0 to 100, wherein “0” was a rating where the state of emergence or growth of a sample weed during a test had no difference or little difference compared with the state of the test weed that did not subjected to the treatment, and “100” was a rating where the test plant was completely killed or the emergence or growth of the test weed was completely suppressed.

The harmful effect on crops was rated as “harmless” when little harmful effect was observed, “low” when a moderate level of harmful effect was observed, “medium” when a medium level of harmful effect was observed, and “high” when a high level of harmful effect was observed.

### Example 1

The weeds (palmer amaranth (Amaranthus palmeri), waterhemp (Amaranthus tuberculatus=Amaranthus rudis=Amaranthus tamariscinus), common ragweed (Ambrosia artemisiifolia), giant ragweed (Ambrosia trifida), Canadian horseweed (Conyza canadensis), common lambsquarters (Chenopodium album), Kochia (Kochia scoparia), common barnyardgrass (Echinochloa crus-galli) and giant foxtail (Setaria faberi)) are seeded in a plastic pot. On the same day, a spray liquid containing the compound (I-15) and pyroxasulfone prepared so that the application rate of the compound (I-15) might be 25, 50, 100 or 200 g/ha and the application rate of ZIDUA (pyroxasulfone 85% water dispersible granule, manufactured by BASF Corporation) might be 70, 140 or 280 g/ha (1, 2 or 4 ounce/acre) is applied to the surface of soil so that the spray liquid amount may be 200 L/ha. The weeds are then cultivated in a greenhouse, and 7 days after the application, soybeans are seeded. Fourteen days after seeding the soybeans, the effect on the weeds and crop injuries on the soybeans are investigated. A synergistic weed control effect compared to the single use of each of the compounds is confirmed.

### Example 2

The weeds (palmer amaranth (Amaranthus palmeri), waterhemp (Amaranthus tuberculatus=Amaranthus rudis=Amaranthus tamariscinus), common ragweed (Ambrosia artemisiifolia), giant ragweed (Ambrosia trifida), Canadian horseweed (Conyza canadensis), common lambsquarters (Setaria faberi)) and soybeans are seeded in a plastic pot. On the same day, a spray liquid containing the compound (I-15) and saflufenacil prepared so that the application rate of the compound (I-15) might be 25, 50, 100 or 200 g/ha and the application rate of Sharpen (saflufenacil 29.7% wettable powder, manufactured by BASF SE) might be 73 mL/ha (1 fluid ounce/acre) is applied to the surface of soil so that the spray liquid amount may be 200 L/ha. The weeds and soybeans are then cultivated in a greenhouse, and 21 days after the application, the effect on the weeds and crop injuries on soybeans are investigated. A synergistic weed control effect compared to the single use of each of the compounds is confirmed.

### Example 3

The weeds (palmer amaranth (Amaranthus palmeri), waterhemp (Amaranthus tuberculatus=Amaranthus rudis=Amaranthus tamariscinus), common ragweed (Ambrosia artemisiifolia), giant ragweed (Ambrosia trifida), Canadian horseweed (Conyza canadensis), common lambsquarters (Chenopodium album), Kochia (Kochia scoparia), common barnyardgrass (Echinochloa crus-galli) and giant foxtail (Setaria faberi)) and soybeans are seeded in a plastic pot. On the same day, a spray liquid containing the compound (I-15) and flumioxazin prepared so that the application rate of the compound (I-15) might be 25, 50, 100 or 200 g/ha and the application rate of Valor SX (flumioxazin 51% wettable powder, manufactured by Valent U.S.A. LLC) might be 140 g/ha (2 ounce/acre) is applied to the surface of soil so that the spray liquid amount may be 200 L/ha. The weeds and soybeans are then cultivated in a greenhouse, and 21 days after the application, the effect on the weeds and crop injuries on soybeans are investigated. A synergistic weed control effect compared to the single use of each of the compounds is confirmed.

### Examples 4 to 6

The Examples 4 to 6 are performed in the same manner, except that soybean of Examples 1 to 3 is replaced by corn or cotton. A synergistic weed control effect compared to the single use of each of the compounds is confirmed.

### Example 7

The weeds (palmer amaranth (Amaranthus palmeri), waterhemp (Amaranthus tuberculatus=Amaranthus rudis=Amaranthus tamariscinus), common ragweed (Ambrosia artemisiifolia), giant ragweed (Ambrosia trifida), Canadian horseweed (Conyza canadensis), common lambsquarters (Chenopodium album), Kochia (Kochia scoparia), common barnyardgrass (Echinochloa crus-galli) and giant foxtail (Setaria faberi)) are seeded in a plastic pot. The weeds are then cultivated in a greenhouse, and 21 days after the seeding, a spray liquid containing the compound (I-15) and glyphosate-potassium salt prepared so that the application rate of the compound (I-15) might be 25, 50, 100 or 200 g/ha and the application rate of RoundupWeatherMax (660 g/L of glyphosate-potassium salt, manufactured by Monsanto Company) might be 2.338 L/ha (32 fluid ounce/acre) is applied to the foliage so that the spray liquid amount may be 200 L/ha. The weeds are further cultivated in a greenhouse, and 7 days and 14 days after the application, the effect on the weeds are investigated. A synergistic weed control effect compared to the single use of each of the compounds is confirmed.

### Example 8

The weeds (palmer amaranth (Amaranthus palmeri), waterhemp (Amaranthus tuberculatus=Amaranthus rudis=Amaranthus tamariscinus), common ragweed (Ambrosia artemisiifolia), giant ragweed (Ambrosia trifida), Canadian horseweed (Conyza canadensis), common lambsquarters (Chenopodium album), Kochia (Kochia scoparia), common barnyardgrass (Echinochloa crus-galli) and giant foxtail (Setaria faberi)) are seeded in a plastic pot. On the same day, a spray liquid containing the compound (I-15) prepared so that the application rate of the compound (I-15) might be 25, 50, 100 or 200 g/ha is applied to the surface of soil so that the spray liquid amount may be 200 L/ha. The weeds are then cultivated in a greenhouse, and at 7 days after the application, soybeans are seeded, and then spray liquid containing pyroxasulfone prepared so that the application rate of ZIDUA (pyroxasulfone 85% water dispersible granule, manufactured by BASF SE) might be 70, 140 or 280 g/ha (1, 2 or 4 ounce/acre) is applied so that the spray liquid amount may be 200 L/ha. Fourteen days after the application, the effect on the weeds and crop injuries on soybeans are investigated. A synergistic weed control effect compared to the single use of each of the compounds is confirmed.

### Example 9

The weeds (palmer amaranth (Amaranthus palmeri), waterhemp (Amaranthus tuberculatus=Amaranthus rudis=Amaranthus tamariscinus), common ragweed (Ambrosia artemisiifolia), giant ragweed (Ambrosia trifida), Canadian horseweed (Conyza canadensis), common lambsquarters (Chenopodium album), Kochia (Kochia scoparia), common barnyardgrass (Echinochloa crus-galli) and giant foxtail (Setaria faberi)) are seeded in a plastic pot. On the same day, a spray liquid containing the compound (I-15) prepared so that the application rate of the compound (I-15) might be 25, 50, 100 or 200 g/ha is applied to the surface of soil so that the spray liquid amount may be 200 L/ha. The weeds are then cultivated in a greenhouse, and at 7 days after the application, soybeans are seeded. A spray liquid containing saflufenacil prepared so that the application rate of Sharpen (saflufenacil 29.7% wettable powder, manufactured by BASF SE) might be 73 mL/ha (1 fluid ounce/acre) is applied so that the spray liquid amount may be 200 L/ha. Fourteen days after the application, the effect on the weeds and crop injuries on soybeans are investigated. A synergistic weed control effect compared to the single use of each of the compounds is confirmed.

### Example 10

The weeds (palmer amaranth (Amaranthus palmeri), waterhemp (Amaranthus tuberculatus=Amaranthus rudis=Amaranthus tamariscinus), common ragweed (Ambrosia artemisiifolia), giant ragweed (Ambrosia trifida), Canadian horseweed (Conyza canadensis), common lambsquarters (Setaria faberi)) are seeded in a plastic pot. On the same day, a spray liquid containing the compound (I-15) prepared so that the application rate of the compound (I-15) might be 25, 50, 100 or 200 g/ha is applied to the surface of soil so that the spray liquid amount may be 200 L/ha. The weeds are then cultivated in a greenhouse, and at 7 days after the application, soybeans are seeded. A spray liquid containing flumioxazin prepared so that the application rate of Valor SX (flumioxazin 51% wettable powder, manufactured by Valent U.S.A. LLC) might be 140 g/ha (2 ounce/acre) is applied so that the spray liquid amount may be 200 L/ha. Fourteen days after the application, the effect on the weeds and crop injuries on soybeans are investigated. A synergistic weed control effect compared to the single use of each of the compounds is confirmed.

### Examples 11 to 13

In each test of Examples 8 to 10, RoundupPowerMax (660 g/L of glyphosate-potassium salt, manufactured by Monsanto Company) is further added to the compound (I-15) so that the application rate may be 2.338 L/ha (32 fluid ounce/acre, 1, 543 g/ha as glyphosate-potassium salt), followed by application in the same manner. A synergistic weed control effect compared to the single use of each of the compounds is confirmed.

### Example 14

The weeds (palmer amaranth (Amaranthus palmeri), waterhemp (Amaranthus tuberculatus=Amaranthus rudis=Amaranthus tamariscinus), common ragweed (Ambrosia artemisiifolia), giant ragweed (Ambrosia trifida), Canadian horseweed (Conyza canadensis), common lambsquarters (Chenopodium album), Kochia (Kochia scoparia), common barnyardgrass (Echinochloa crus-galli) and giant foxtail (Setaria faberi)) are seeded in a plastic pot. On the same day, a spray liquid containing the compound (I-15) prepared so that the application rate of the compound (I-15) might be 25, 50, 100 or 200 g/ha is applied to the surface of soil so that the spray liquid amount may be 200 L/ha. The weeds are then cultivated in a greenhouse, and at 7 days after the application, soybeans are seeded. Fourteen days after seeding the soybeans, a spray liquid containing glyphosate-potassium salt prepared so that the application rate of RoundupWeatherMax (660 g/L of glyphosate-potassium salt, manufactured by Monsanto Company) might be 2.338 L/ha (32 fluid ounce/acre) is applied so that the spray liquid amount may be 200 L/ha. Fourteen days after the application (28 days after the seeding), the effect on the weeds and crop injuries on soybeans are investigated. A synergistic weed control effect compared to the single use of each of the compounds is confirmed.

### Example 15

In the application of the compound (I-15) of Example 14, RoundupPowerMax (660 g/L of glyphosate-potassium salt, manufactured by Monsanto Company) is further added so that the application rate may be 2.338 L/ha (32 fluid ounce/acre, 1, 543 g/ha as glyphosate-potassium salt), followed by application in the same manner. A synergistic weed control effect compared to the single use of each of the compounds is confirmed.

### Examples 16 to 23

The Examples 16 to 23 are performed in the same manner, except that soybean of Examples 8 to 15 is replaced by corn or cotton.

### Examples 24 to 46

The Examples 24 to 46 are performed in the same manner, except that the compound (I-15) of Examples 1 to 23 is replaced by the compound (I-29). A synergistic weed control effect compared to the single use of each of the compounds is confirmed.

### Examples 47 to 69

The Examples 47 to 69 are performed in the same manner, except that the compound (I-15) of Examples 1 to 23 is replaced by the compound (I-30). A synergistic weed control effect compared to the single use of each of the compounds is confirmed.

### Examples 70 to 92

The Examples 70 to 92 are performed in the same manner, except that the compound (I-15) in Examples 1 to 23 is replaced by the compound (I-33).

A synergistic weed control effect compared to the single use of each of the compounds is confirmed.

### Examples 93 to 115

The Examples 93 to 115 are is performed in the same manner, except that the compound (I-15) in Examples 1 to 23 is replaced by the compound (I-41). A synergistic weed control effect compared to the single use of each of the compounds is confirmed.

### Examples 116 to 230

The Examples 116 to 230 are performed in the same manner, except that the crop in Examples 1 to 115 is replaced by crops with Roundup Ready 2 Xtend trait. A synergistic weed control effect compared to the single use of each of the compounds is confirmed.

### Examples 231 to 345

The Examples 231 to 345 are performed in the same manner, except that the crop in Examples 1 to 115 is replaced by crops produced by a transgenic technique having both Roundup Ready 2 Xtend trait and trait having tolerance to a PPO inhibitor due to having exogenous PPO in which the affinity to a PPO inhibitor to be applied is lower than endogenous PPO in crops. A synergistic weed control effect compared to the single use of each of the compounds is confirmed.

### Example 346

The compound (I-15) (55 mg), 76.5 mg of Emulsogen TS290 (polyoxyethylene tristyryl phenyl ether, manufactured by Clariant) and 76.5 mg of Phenylsulfonat CAL (mixture of 70% calcium dodecylbenzenesulfonate and 30% iso-butanol, manufactured by Clariant) were dissolved in Solvesso 200ND (aromatic hydrocarbon, manufactured by Exxon Mobile Corporation) to make 1 ml in total, thus producing an emulsifiable concentrate (hereinafter referred to as formulation (I-15)).

After filling a plastic pot with soil, common barnyardgrass (Echinochloa crus-galli) and Italian ryegrass (Lolium multiflorum) were seeded therein and grown in a greenhouse. The weeds were then cultivated in the greenhouse, and 17 days after seeding, a spray liquid containing the formulation (1-15) and/or Roundup PowerMax (660 g/L of glyphosate potassium salt, manufactured by Monsanto Company) prepared so that the application rate of the compound (I-15) might be 20 g/ha and the application rate of Roundup PowerMax might be 1262 g/ha as an equivalent of glyphosate acid (2.338 L/ha (32 fluid ounce/acre) as Roundup PowerMax) was uniformly sprayed above the pot using a spraying machine so that the spray liquid amount may be 218 L/ha. Thereafter, the weeds were grown in the greenhouse for 4 days and the herbicidal effect was evaluated.

From the results of the herbicidal effect (value of A or B) for the single use of each of the compounds, the expected value of the herbicidal effect when the compounds were combined was determined according to the Colby's equation:

$$Expected value = 100 - ( 100 - A ) \times ( 100 - B ) / 100.$$

The results are shown in Table 3.

TABLE 3

| | | Herbicidal effect | | | |
|---|---|---|---|---|---|
| Application rate | | Common barnyardgrass | | Italian ryegrass | |
| (g/ha) | | (Echinochloa crus-galli) | | (Lolium multiflorum) | |
| Com- | Glyphosate | Ob- | Ex- | Ob- | Ex- |
| pound | potassium | served | pected | served | pected |
| (I-15) | salt | value | value | value | value |
| 20 | — | 70 | — | 20 | — |
| — | 1,262 | 30 | — | 10 | — |
| 20 | 1,262 | 95 | 79 | 80 | 28 |

### Example 347

The formulation (I-15) was produced in the same manner as in Example 346.

After filling a plastic pot with soil, common barnyardgrass (Echinochloa crus-galli) and Italian ryegrass (Lolium multiflorum) were seeded therein and grown in a greenhouse. The weeds were then cultivated in the greenhouse, and 17 days after seeding, a spray liquid containing the formulation (1-15) and/or Xtendimax (350 g/L of dicamba diglycolamine salt, manufactured by Monsanto Company) prepared so that the application rate of the compound (I-15) might be 20 g/ha and the application rate of Xtendimax might be 560 g/ha as an equivalent of dicamba acid (1.608 L/ha (22.0 fluid ounce/acre) as Xtendimax) was uniformly sprayed above the pot using a spraying machine so that the spray liquid amount might be 218 L/ha. Thereafter, the weeds were grown in the greenhouse for 4 days and the herbicidal effect was evaluated.

From the results of the herbicidal effect (value of A or B) for the single use of each of the compounds, the expected value of the herbicidal effect when the compounds were combined was determined according to the Colby's equation:

$$Expected value = 100 - ( 100 - A ) \times ( 100 - B ) / 100.$$

The results are shown in Table 4.

TABLE 4

| Application rate | | Herbicidal effect | | | |
|---|---|---|---|---|---|
| (g/ha) | | Common barnyardgrass | | Italian ryegrass | |
| | Dicamba | (Echinochloa crus-galli) | | (Lolium multiflorum) | |
| Com- | di- | Ob- | Ex- | Ob- | Ex- |
| pound | glycolamine | served | pected | served | pected |
| (I-15) | salt | value | value | value | value |
| 20 | — | 70 | — | 20 | — |
| — | 560 | 5 | — | 0 | — |
| 20 | 560 | 80 | 71.5 | 70 | 20 |

### Example 348

The compound (I-41) (55 mg), 76.5 mg of Emulsogen TS290 (polyoxyethylene tristyryl phenyl ether, manufactured by Clariant) and 76.5 mg of Phenylsulfonat CAL (mixture of 70% calcium dodecylbenzenesulfonate and 30% iso-butanol, manufactured by Clariant) were dissolved in Solvesso 200ND (aromatic hydrocarbon, manufactured by Exxon Mobile Corporation) to make 1 ml in total, thus producing an emulsifiable concentrate (hereinafter referred to as formulation (I-41)).

After filling a plastic pot with soil, common barnyardgrass (Echinochloa crus-galli) and Italian ryegrass (Lolium multiflorum) were seeded therein and grown in a greenhouse. The weeds were then cultivated in the greenhouse, and 17 days after seeding, a spray liquid containing the formulation (1-41) and/or Liberty (280 g/L of glufosinate ammonium salt, manufactured by Bayer) prepared so that the application rate of the compound (I-41) might be 20 g/ha and the application rate of Liberty might be 594 g/ha as glufosinate ammonium salt (2.12 L/ha (29.0 fluid ounce/acre) as Liberty) was uniformly sprayed above the pot using a spraying machine so that the spray liquid amount might be 218 L/ha. Thereafter, the weeds were grown in the greenhouse for 4 days and the herbicidal effect was evaluated.

From the results of the herbicidal effect (value of A or B) for the single use of each of the compounds, the expected value of the herbicidal effect when the compounds were combined was determined according to the Colby's equation:

$$Expected value = 100 - ( 100 - A ) \times ( 100 - B ) / 100.$$

The results are shown in Table 5.

TABLE 5

| | | Herbicidal effect | | | |
|---|---|---|---|---|---|
| Application rate | | Common barnyardgrass | | Italian ryegrass | |
| (g/ha) | | (Echinochloa crus-galli) | | (Lolium multiflorum) | |
| Com- | Glufosinate | Ob- | Ex- | Ob- | Ex- |
| pound | ammonium | served | pected | served | pected |
| (I-41) | salt | value | value | value | value |
| 20 | — | 50 | — | 20 | — |
| — | 594 | 70 | — | 40 | — |
| 20 | 594 | 95 | 85 | 75 | 52 |

### Example 349

The formulation (1-41) was produced in the same manner as in Example 348.

After filling a plastic pot with soil, common barnyardgrass (Echinochloa crus-galli) and Italian ryegrass (Lolium multiflorum) were seeded therein and grown in a greenhouse. The weeds were then cultivated in the greenhouse, and 21 days after seeding, a spray liquid containing the formulation (1-41) and/or EnlistOne (670 g/L of 2,4-D choline salt, manufactured by Dow AgroSciences) prepared so that the application rate of the compound (I-41) might be 20 g/ha and the application rate of EnlistOne might be 798 g/ha as an equivalent of 2,4-D choline salt (1.754 L/ha (24 fluid ounce/acre) as RoundupWeatherMax) was uniformly sprayed above the pot using a spraying machine so that the spray liquid amount might be 218 L/ha. Thereafter, the weeds were grown in the greenhouse for 4 days and the herbicidal effect was evaluated.

From the results of the herbicidal effect (value of A or B) for the single use of each of the compounds, the expected value of the herbicidal effect when the compounds were combined was determined according to the Colby's equation:

$$Expected value = 100 - ( 100 - A ) \times ( 100 - B ) / 100.$$

The results are shown in Table 6.

TABLE 6

| Application rate | | Herbicidal effect | | | |
|---|---|---|---|---|---|
| (g/ha) | | Common barnyardgrass | | Italian ryegrass | |
| | 2,4-D | (Echinochloa crus-galli) | | (Lolium multiflorum) | |
| Compound | choline | Observed | Expected | Observed | Expected |
| (I-41) | salt | value | value | value | value |
| 20 | — | 70 | — | 20 | — |
| — | 798 | 10 | — | 5 | — |
| 20 | 798 | 90 | 73 | 60 | 24 |

### INDUSTRIAL APPLICABILITY

The present composition and the present method can be used for controlling weeds effectively.

1. A herbicidal composition comprising one or more uracil compounds represented by the following formula (I): 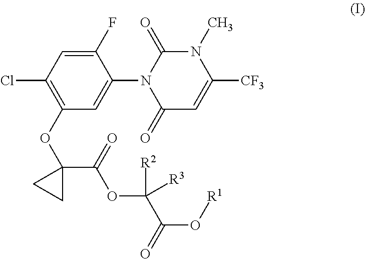
wherein,
R¹ represents a hydrogen atom, a methyl group, or an ethyl group,
R² represents an alkyl group having 1 to 3 carbon atoms,
R³ represents a hydrogen atom or an alkyl group having 1 to 3 carbon atoms, and
R² and R³ may be bonded to each other to form a C2-3 alkylene chain,
and one or more compounds selected from the herbicide compound group B, and
the herbicide compound group B is the group consisting of the following B-1 to B-12:
B-1, acetolactate synthase inhibitors;
B-2, acetyl CoA carboxylase inhibitors;
B-3, protoporphyrinogen IX oxidase inhibitors;
B-4, 4-hydrophenylpyruvic acid dioxygenase inhibitors;
B-5, phytoene desaturase inhibitors;
B-6, photosystem II inhibitors;
B-7, very long-chain fatty acid synthesis inhibitors;
B-8, microtubule formation inhibitors;
B-9, auxin-type herbicides:
B-10, enolpyruvylshikimate-3-phosphate synthase inhibitors;
B-11, glutamine synthase inhibitors; and
B-12, other herbicides;
(including agriculturally acceptable salts or derivatives thereof).

2. The herbicidal composition according to claim 1, wherein the B-1 is the group consisting of:
pyrithiobac, pyrithiobac-sodium salt, pyriminobac, pyriminobac-methyl, bispyribac, bispyribac-sodium salt, pyribenzoxim, pyrimisulfan, pyriftalid, triafamone, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron methyl-sodium, foramsulfuron, halosulfuron, halosulfuron-methyl, imazosulfuron, metsulfuron, metsulfuron-methyl, metazosulfuron, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron, trifloxysulfuron-sodium salt, chlorsulfuron, cinosulfuron, ethametsulfuron, ethametsulfuron-methyl, iodosulfuron, iodosulfuron-methyl-sodium, iofensulfuron, iofensulfuron-sodium, mesosulfuron, mesosulfuron-methyl, prosulfuron, thifensulfuron, thifensulfuron-methyl, triasulfuron, tribenuron, tribenuron-methyl, triflusulfuron, triflusulfuron-methyl, tritosulfuron, bencarbazone, flucarbazone, flucarbazone-sodium salt, propoxycarbazone, propoxycarbazone-sodium salt, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium salt, imazapic, imazapic-ammonium salt, imazapyr, imazapyr-isopropylammonium salt, imazaquin, imazaquin-ammonium salt, imazethapyr, and imazethapyr-ammonium salt
(including agriculturally acceptable salts or derivatives thereof),
the B-2 is the group consisting of:
clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-ethotyl, haloxyfop-methyl, haloxyfop-P, haloxyfop-P-ethotyl, haloxyfop-P-methyl, metamifop, propaquizafop, quizalofop, quizalofop-tefuryl, quizalofop-ethyl, quizalofop-P, quizalofop-P-tefuryl, quizalofop-P-ethyl, alloxydim, butroxydin, clethodim, cycloxydim, profoxydim, sethoxydim, tepraloxydim, tralkoxydim, and pinoxaden
(including agriculturally acceptable salts or derivatives thereof),
the B-3 is the group consisting of:
azafenidin, benzfendizone, oxadiazone, oxadiargyl, carfentrazone, carfentrazone-ethyl, saflufenacil, cinidon, cinidon-ethyl, sulfentrazone, pyraclonil, cyclopyranil, pyraflufen, pyraflufen-ethyl, butafenacil, fluazolate, fluthiacet, fluthiacet-methyl, flufenpyr, flufenpyr-ethyl, flumiclorac, flumiclorac-pentyl, flumioxazin, pentoxazone, oxyfluorfen, acifluorfen, acifluorfen-sodium salt, chlomethoxynil, chloronitrofen, nitrofen, bifenox, chlomethoxyfen, ethoxyfentyl, fluoroglycofen, fluoroglycofen-ethyl, fomesafen, fomesafen-sodium, halosafen, lactofen, tiafenacil, trifludimoxazin, thidiazimin, profluazole, and epyrifenacil
(including agriculturally acceptable salts or derivatives thereof),
the B-4 is the group consisting of:
benzobicyclon, bicyclopyrone, mesotrione, sulcotrione, tefuryltrione, tembotrione, isoxachlorotole, isoxaflutole, benzofenap, pyrasulfotole, pyrazolynate, pyrazoxyfen, fenquinotrione, topramezone, tolpyralate, lancotrione, lancotrione-sodium salt, 2-methyl-N-(5-methyl-1,3,4-oxadiazol-2-yl)-3-(methanesulfonyl)-4-(trifluoromethyl)benzamide (CAS registry No.: 1400904-50-8), 2-chloro-N-(1-methyl-1H-tetrazol-S-yl)-3-(methylthio)-4-(trifluoromethyl)benzamide (CAS registry No.: 1361139-71-0), 4-(4-fluorophenyl)-6-[(2-hydroxy-6-oxo-1-cyclohexen-1-yl)carbonyl]-2-methyl-1,2,4-triazine-3,5(2H,4H)-dione (CAS registry No.: 1353870-34-4), and 3˜ [(isopropylsulfonyl)methyl]-N-(5-methyl-1,3,4-oxadiazol-2-yl)-5-(trifluoromethyl)-1,2,4-triazolo[4,3-a]pyridine-&-carboxamide (CAS registry No.: 1994348-72-9)
(including agriculturally acceptable salts or derivatives thereof),
the B-5 is the group consisting of:
diflufenican, picolinafen, beflubutamid, norflurazon, fluridone, flurochloridone, and flurtamone
(including agriculturally acceptable salts or derivatives thereof),
the B-6 is the group consisting of:
ioxynil, ioxynil octanoate, bentazone, pyridafol, pyridate, bromophenoxym, bromoxynil, bromoxynil octanoate, chlorbromuron, chlorotoluron, chloroxuron, dimefuron, diuron, ethidimuron, fenuron, linuron, fluometuron, isoproturon, isouron, tebuthiuron, azuron, methabenzthiazuron, neburon, pentanochlor, propanil, metobromuron, metoxuron, monolinuron, siduron, simazine, atrazine, desmetryn, propazine, cyanazine, ametryn, simetryn, dimethametryn, prometon, prometryn, terbumeton, terbuthylazine, terbutryn, trietazine, hexazinone, metamitron, metribuzin, amicarbazone, bromacil, lenacil, terbacil, chloridazon, desmedipham, and phenmedipham
(including agriculturally acceptable salts or derivatives thereof),
the B-7 is the group consisting of:
propachlor, metazachlor, alachlor, acetochlor, aridchlor, dimethachlor, metolachlor, S-metolachlor, butachlor, pretilachlor, propisochlor, thenylchlor, indanofan, cafenstrole, fentrazamide, diphenamid, dimethenamid, dimethenamid-P, dimepiperate, mefenacet, pyroxasulfone, fenoxasulfone, naproanilide, napropamide, napropamide M, pethoxamid, anilofos, piperofos, flufenacet, dimesulfazet, and ipfencarbazone
(including agriculturally acceptable salts or derivatives thereof),
the B-8 is the group consisting of:
trifluralin, pendimethalin, ethalfluralin, benfluralin, oryzalin, prodiamine, butamifos, dithiopyr, thiazopyr, amiprophos-methyl, carbetamide, chlorthal-dimethyl, butralin, dinitramine, propham, propyzamide, and tebutam
(including agriculturally acceptable salts or derivatives thereof),
the B-9 is the group consisting of:
2,3,6-TBA and a salt or ester thereof (dimethylammonium, lithium salt, potassium salt, sodium salt), 2,4-D and a salt or ester thereof (choline salt, tetrabutylammonium salt, biproamine, doboxyl, 2-ethylhexyl, 3-butoxypropyl, ammonium, butotyl, butyl, diethylammonium, dimethylammonium, diolamine salt, dodecylammonium, ethyl, heptylammonium, isobutyl, isooctyl, isopropyl, isopropylammonium, lithium salt, meptyl, methyl, octyl, pentyl, propyl, sodium salt, tefuryl, tetradecylammonium, triethylammonium, tris(2-hydroxypropyl)ammonium, and trolamine salt), 2,4-DB and a salt or ester thereof (choline salt, biproamine, butyl, dimethylammonium, isooctyl, potassium salt and sodium salt), MCPA and a salt or ester thereof (choline salt, biproamine, etexyl, butotyl, butyl, dimethylammonium, diolamine salt, ethyl, isobutyl, isooctyl, isopropyl, methyl, olamine salt, sodium salt and trolamine salt), MCPB and a salt or ester thereof (choline salt, biproamine, ethyl, methyl and sodium salt), mecoprop and a salt or ester thereof (choline salt, biproamine, 2-ethylhexyl, dimethylammonium, diolamine salt, ethadyl, isooctyl, methyl, potassium salt, sodium salt and trolamine salt), mecoprop-P and a salt or ester thereof (choline salt, 2-ethylhexyl, dimethylammonium, isobutyl, and potassium salt), dichlorprop and a salt or ester thereof (choline salt, biproamine, etexyl, butotyl, dimethylammonium, ethylammonium, isooctyl, methyl, potassium salt and sodium salt), dichlorprop-P and a salt or ester thereof (choline salt, biproamine, etexyl and dimethylammonium), dicamba and a salt or ester thereof (choline salt, biproamine, trolamine salt, diglycolamine salt, dimethylammonium, diolamine salt, isopropylammonium, methyl, olamine salt, potassium salt, sodium salt and tetrabutylammonium salt), triclopyr and a salt or ester thereof (butotyl, ethyl and triethylammonium), fluroxypyr and a salt or ester thereof (meptyl and butometyl), picloram and a salt thereof (potassium salt, tris(2-hydroxypropyl)ammonium salt and choline salt), quinclorac, quinmerac, aminopyralid and a salt thereof (choline salt, potassium salt and tripromine), clopyralid and a salt thereof (choline salt, methyl, olamine salt, potassium salt, tris(2-hydroxypropyl)ammonium, and triethylammonium salt), clomeprop, aminocyclopyrachlor and a salt thereof (methyl, potassium salt), halauxifen, halauxifen-methyl, florpyrauxifen, florpyrauxifen-benzyl, benazolin-ethyl, chloramben, 4-amino-3-chloro-5-fluoro-6-(7-fluoro-1H-indol-6-yl)pyridine-2-carboxylic acid, and 4-amino-3-chloro-5-fluoro-6-(7-fluoro-1H-indol-6-yl)pyridine-2-carboxylic cyanomethyl ester
(including agriculturally acceptable salts or derivatives thereof),
the B-10 is the group consisting of:
glyphosate, glyphosate choline salt, glyphosate-isopropylammonium, glyphosate biproamine, glyphosate-trimesium, glyphosate-ammonium salt, glyphosate-diammonium salt, glyphosate-dimethylammonium salt, glyphosate-monoethanolamine salt, glyphosate-sodium salt, glyphosate-potassium salt, and glyphosate-guanidine salt
(including agriculturally acceptable salts or derivatives thereof),
the B-11 is the group consisting of:
glufosinate, glufosinate-ammonium salt, glufosinate-P, glufosinate-P-sodium salt, glufosinate-P-ammonium salt, and bialaphos
(including agriculturally acceptable salts or derivative thereof), and
the B-12 is the group consisting of:
aclonifen, isoxaben, dichlobenil, thaxtomin A, methiozolin, diallate, butylate, triallate, chlorpropham, asulam, phenisopham, benthiocarb, molinate, esprocarb, pyributicarb, prosulfocarb, orbencarb, EPTC, dimepiperate, swep, difenoxuron, methyl daimuron, bromobutide, daimuron, cumyluron, diflufenzopyr, diflufenzopyr-sodium salt, naptalam, etobenzanid, tridiphane, amitrole, clomazone, bixlozone, maleic hydrazide, oxaziclomefone, cinmethylin, benfuresate, ACN, dalapon, chlorthiamid, flupoxam, bensulide, paraquat, paraquat-dichloride, diquat, diquat-dibromide, MSMA, indaziflam, triaziflam, tetflupyrolimet, dinoseb, dinoterb, DNOC, cycloate, ethofumesate, flupropanate, pebulate, TCA, TCA-ammonium, TCA-calcium, TCA-ethadyl, TCA-magnesium, TCA-sodium, tiocarbazil, vernolate, cyclopyrimorate, dazomet, difenzoquat, difenzoquat methyl sulphate, DSMA, flamprop M, flurenol, fosamine, metam, oleic acid, pelargonic acid, (2R,4R)-4-({[(5S)-3-(3,5-difluorofenyl)-5-vinyl-4,5-dihydroisoxazol-5-yl]carbonyl}amino)tetrahydrofuran-2-carboxylic methyl ester and (2S,4S)-4-({[(5R)-3-(3,5-difluorofenyl)-5-vinyl-4,5-dihydroisoxazol-5-yl]carbonyl}amino)tetrahydrofuran-2-carboxylic methyl ester, icafolin-methyl (CAS registry No.: 2749998-21-6), 1-{2-chloro-6-[(5-chloropyrimidin-2-yl)oxy]phenyl}-4,4,4-trifluorobutan-1-one (CAS registry No.: 2052297-97-7), and rimisoxafen (CAS registry No.: 1801862-02-01)
(including agriculturally acceptable salts or derivatives thereof).

3. The herbicidal composition according to claim 1, wherein the B-1 is the group consisting of:
pyrithiobac, pyrithiobac-sodium salt, chlorimuron-ethyl, foramsulfuron, halosulfuron-methyl, nicosulfuron, primisulfuron-methyl, rimsulfuron, trifloxysulfuron-sodium salt, chlorsulfuron, iodosulfuron-methyl-sodium, iofensulfuron-sodium, mesosulfuron-methyl, prosulfuron, thifensulfuron-methyl, tribenuron-methyl, thiencarbazone-methyl, cloransulam-methyl, flumetsulam, imazamethabenz-methyl, imazamox-ammonium salt, imazapic-ammonium salt, imazapyr-isopropylammonium, imazaquin-ammonium salt, and imazethapyr-ammonium salt
(including agriculturally acceptable salts or derivatives thereof).

4. The herbicidal composition according to claim 1, wherein the B-2 is the group consisting of:
fenoxaprop-ethyl, fenoxaprop-P-ethyl, fluazifop-butyl, fluazifop-P-butyl, quizalofop-ethyl, quizalofop-P-ethyl, clethodim, and sethoxydim
(including agriculturally acceptable salts or derivatives thereof).

5. The herbicidal composition according to claim 1, wherein the B-3 is the group consisting of:
carfentrazone-ethyl, saflufenacil, sulfentrazone, pyraflufen-ethyl, fluthiacet-methyl, flufenpyr-ethyl, flumiclorac-pentyl, flumioxazin, oxyfluorfen, acifluorfen-sodium salt, fomesafen-sodium, lactofen, tiafenacil, trifludimoxazin, and epyrifenacil
(including agriculturally acceptable salts or derivatives thereof).

6. The herbicidal composition according to claim 1, wherein the B-4 is the group consisting of:
bicyclopyrone, mesotrione, tembotrione, isoxaflutole, fenquinotrione, topramezone, tolpyralate, lancotrione-sodium salt, 2-methyl-N-(5-methyl-1,3,4-oxadiazol-2-yl)-3-(methanesulfonyl)-4-(trifluoromethyl)benzamide (CAS registry No. 1400904-50-8), 2-chloro-N-(1-methyl-1H-tetrazol-5-yl)-3-(methylthio)-4-(trifluoromethyl)benzamide (CAS registry No. 1361139-71-0), and 4-(4-fluorophenyl)-6-[(2-hydroxy-6-oxo-1-cyclohexen-1-yl)carbonyl]-2-methyl-1,2,4-triazine-3,5(2H,4H)-dione (CAS registry No. 1353870-34-4)
(including agriculturally acceptable salts or derivatives thereof).

7. The herbicidal composition according to claim 1, wherein the B-5 is the group consisting of:
norflurazon and fluridone
(including agriculturally acceptable derivatives thereof).

8. The herbicidal composition according to claim 1, wherein the B-6 is the group consisting of:
bentazone, bromoxynil octanoate, diuron, linuron, fluometuron, simazine, atrazine, ametryn, prometryn, and metribuzin
(including agriculturally acceptable salts or derivatives thereof).

9. The herbicidal composition according to claim 1, wherein the B-7 is the group consisting of:
alachlor, acetochlor, metolachlor, S-metolachlor, dimethenamid, dimethenamid-P, pyroxasulfone, and flufenacet
(including agriculturally acceptable derivatives thereof).

10. The herbicidal composition according to claim 1, wherein the B-8 is the group consisting of:
trifluralin, pendimethalin, and ethalfluralin
(including agriculturally acceptable derivative thereof).

11. The herbicidal composition according to claim 1, wherein
the B-9 is the group consisting of:
2,4-D, 2,4-D choline salt, 2,4-DB, dicamba, dicamba-biproamine, dicamba-diglycolamine salt, fluroxypyr, fluroxypyr-meptyl, clopyralid-olamine salt, clopyralid-potassium salt, clopyralid-triethylammonium salt, halauxifen, halauxifen-methyl, florpyrauxifen, and florpyrauxifen-benzyl
(including agriculturally acceptable salts or derivatives thereof).

12. The herbicidal composition according to claim 1, wherein the B-10 is the group consisting of:
glyphosate, glyphosate-isopropylammonium, glyphosate-ammonium salt, glyphosate-dimethylamine salt, glyphosate-monoethanolamine salt, glyphosate-potassium salt, and glyphosate-guanidine salt
(including agriculturally acceptable salts or derivatives thereof).

13. The herbicidal composition according to claim 1, wherein the B-11 is the group consisting of:
glufosinate, glufosinate-ammonium salt, glufosinate-P, and glufosinate-P-sodium salt
(including agriculturally acceptable salts or derivatives thereof).

14. The herbicidal composition according to claim 1, wherein the B-12 is the group consisting of:
EPTC, diflufenzopyr, diflufenzopyr-sodium salt, clomazone, bixlozone, cinmethylin, MSMA, paraquat, paraquat-dichloride, diquat, diquat-dibromide, tetflupyrolimet, and rimisoxafen
(including agriculturally acceptable salts or derivatives thereof).

15. The herbicidal composition according to claim 1, further comprising a carrier.

16. A method for controlling weeds, comprising a step of simultaneously or sequentially applying one or more uracil compounds represented by the following formula (I): 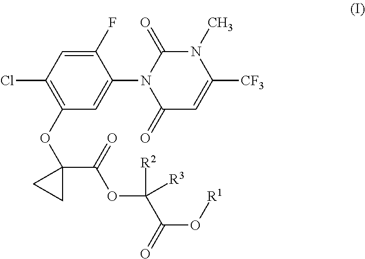
wherein,
R¹ represents a hydrogen atom, a methyl group, or an ethyl group,
R² represents an alkyl group having 1 to 3 carbon atoms,
R³ represents a hydrogen atom or an alkyl group having 1 to 3 carbon atoms, and
R² and R³ may be bonded to each other to form a C2-3 alkylene chain,
and one or more compounds selected from the herbicide compound group B to the place where weeds are growing or will grow, wherein
the herbicide compound group B is the group consisting of the following B-1 to B-12:
B-1, acetolactate synthase inhibitors;
B-2, acetyl CoA carboxylase inhibitors;
B-3, protoporphyrinogen IX oxidase inhibitors;
B-4, 4-hydrophenylpyruvic acid dioxygenase inhibitors;
B-5, phytoene desaturase inhibitors;
B-6, photosystem IL inhibitors;
B-7, very-long-chain fatty acid synthesis inhibitors;
B-8, microtubule formation inhibitors;
B-9, auxin-type herbicides;
B-10, enolpyruvylshikimate-3-phosphate synthase inhibitors;
B-11, glutamine synthase inhibitors; and
B-12, other herbicides;
(including agriculturally acceptable salts or derivatives thereof).

17. The method for controlling weeds according to claim 16, wherein a weight ratio of an application rate of the uracil compounds to that of one or more compounds selected from the group consisting of the herbicide compound group B is 1:10\hat{ }15 to 10\hat{ }15:1.

18. The method for controlling weeds according to claim 16, wherein the place where weeds are growing or will grow is a crop field.

19. (canceled)
